(19) United States
(12) Patent Application Publication
(10) Pub. No.: US 2023/0343208 A1
(43) Pub. Date: Oct. 26, 2023

(54) PEDESTRIAN DEVICE, INFORMATION COLLECTION DEVICE, BASE STATION DEVICE, POSITIONING METHOD, USER MANAGEMENT METHOD, INFORMATION COLLECTION METHOD, AND FACILITY MONITORING METHOD

(71) Applicant: Panasonic Holdings Corporation, Osaka (JP)

(72) Inventors: Tsuyoshi UENO, Kanagawa (JP); Hiroaki SUDO, Kanagawa (JP); Toru OKADA, Kanagawa (JP); Toshiteru HAYASHI, Chiba (JP); Yangping SHEN, Fukuoka (JP)

(73) Assignee: Panasonic Holdings Corporation, Osaka (JP)

(21) Appl. No.: 18/032,015

(22) PCT Filed: Sep. 27, 2021
(86) PCT No.: PCT/JP2021/035302

§ 371 Date: Apr. 14, 2023

(30) Foreign Application Priority Data
Oct. 22, 2020 (JP) 2020-177332

(51) Int. Cl. G06T 7/73; G08G 1/01

(52) U.S. Cl. CPC G08G 1/0116; G06T 7/74; G06T 2207/30184

(57) ABSTRACT

A device includes a camera for capturing shot images of road surfaces; a sensor for detecting a pedestrian’s movement; a memory for storing record information including a shot image at a preset record point in association with position data of the record point; and a processor for performing an image-based positioning operation by predicting a next record point to be reached by the pedestrian based on the pedestrian’s movement status from detection results of the sensor; extracting a shot image(s) from the shot images stored in the memory based on the predicted record point; comparing the extracted shot image with a real time image captured by the camera for matching; and acquiring the position data of the record point associated with the matching shot image as the position data of the pedestrian’s current position.

### TECHNICAL FIELD

The present disclosure relates to a pedestrian device carried by a pedestrian and used for positioning the pedestrian to provide the pedestrian’s current position, an information collection device for collecting information required for positioning by the pedestrian device, a base station device for providing information required for positioning by the pedestrian device, and a positioning method performed by the pedestrian device, as well as a user management method, an information collection method and a facility monitoring method each performed by using the pedestrian device.

### BACKGROUND ART

In safe driving assistance wireless systems, in-vehicle terminals mounted in different vehicles perform ITS communications (vehicle-to-vehicle communications) with each other; that is, transmit and receive the position data of the respective vehicles to and from each other, thereby preventing an accident therebetween, or an in-vehicle terminal and a pedestrian terminal performs such TS communications (vehicle-to-pedestrian communications) with each other to exchange the respective positions data, thereby preventing an accident therebetween.

In-vehicle terminals and pedestrian terminals mainly use satellite positioning to acquire position data of vehicles and pedestrians. However, such terminal can adopt other positioning methods, such as PDR (Pedestrian Dead Reckoning). For prevention of traffic accidents, a desirable positioning method is a method capable of acquiring position data with high accuracy.

Known technologies include an image-based positioning method in which a camera captures an image of an area around a vehicle or a pedestrian and a shot image (i.e., an image captured by a camera) is used as a basis for positioning of the vehicle or the pedestrian. Such image-based positioning methods include a method that involves detecting white lines on the road surface based on shot images, and recognizing, as position data of a vehicle, a lane in which the vehicle is traveling (see Patent Documents 1 to 3). Another known method involves acquiring a shot image of a front view of a vehicle, detecting a landmark object in the shot image (e.g., building near the road), and positioning the vehicle based on the landmark object in the shot image.

### PRIOR ART DOCUMENT (S)

### Patent Document(s)

Patent Document 1: JP2754871B
Patent Document 2: JP3333223B
Patent Document 3: JPH06-149360A

### SUMMARY OF THE INVENTION

### Task to Be Accomplished by the Invention

In the case of positioning a pedestrian, a problem is that sudden changes in a moving speed and a moving direction of a pedestrian that often occur makes it difficult to perform precise positioning, even when a PDR positioning operation is used. In the case of a positioning method using a shot image of a front view of a pedestrian, a problem is that a landmark object in the shot image is often hidden by an obstacle such as another pedestrian who is walking in front of the pedestrian. This problem also prevents preside positioning by an image-based positioning method using a camera. In addition, as a pedestrian terminal needs to be made small so as to be easy to carry around by a pedestrian, a positing method to be used by such pedestrian terminals is desirably configured to enable fast execution of processing operations, and reduced processing load on a data processing device.

The present disclosure has been made in view of these problems of the prior art, and a primary object of the present disclosure is to provide a pedestrian device, an information collection device, a base station device, and a positioning method which enable precise positioning of a pedestrian’s current position, fast execution of processing operations, and reduced processing load on a data processing device.

### Means to Accomplish the Task

A first aspect of the present disclosure provides a pedestrian device comprising: a camera for capturing shot images of road surfaces under a pedestrian’s feet; a sensor for detecting a movement of the pedestrian; a memory for storing record information including a shot image of a road surface at a preset record point in association with position data of the record point, the shot image of the record point being preliminarily captured by the camera and stored in the memory; and a processor for performing an image-based positioning operation, wherein the processor performs the image-based positioning operation by predicting a next record point to be reached by the pedestrian based on the pedestrian’s movement status determined from detection results of the sensor; extracting a shot image from the shot images stored in the memory based on the predicted next record point; comparing the extracted shot image with a real time image for matching, aiming to find a matching shot image to a real time image, the real time image being provided from the camera in real time; and acquiring the position data of the record point associated with the matching shot image as the position data of the pedestrian’s current position.

Another aspect of the present disclosure provides an information collection device for collecting the record information to be stored in the pedestrian device of the first aspect, the information collection device comprising: a camera for capturing shot images of road surfaces under a pedestrian’s feet; and a processor configured to set record points on the road in sequence by performing a parallax-based positioning operation to determine a distance between two points on the road surface based on parallaxes in shot images provided from the camera, to thereby collecting record information including the shot image at each record point in association with position data of the record point.

Yet another aspect of the present disclosure provides a base station device for providing information to the pedestrian device of the first aspect, the base station device comprising: a memory for storing record information about one or more record points in an area around the base station device, the record information including a shot image of a road surface at each of the record points in association with position data of the record point, the shot image of the record point being preliminarily captured by the camera and stored in the memory; a communication device for communicating with the pedestrian device; and a processor for controlling the communication device so that the base station device delivers the record information to the pedestrian device located nearby.

Furthermore another aspect of the present disclosure provides a positioning method, wherein the method is performed by a pedestrian device comprising: a camera for capturing shot images of road surfaces under a pedestrian’s feet; a sensor for detecting a movement of the pedestrian; a memory for storing record information including a shot image of a road surface at a preset record point in association with position data of the record point, the shot image being preliminarily captured by the camera and stored in the memory; and a processor, and wherein the processor performs an image-based positioning operation, the image-based positioning operation comprising: predicting a next record point to be reached by the pedestrian based on the pedestrian’s movement status determined from detection results of the sensor; extracting a shot image from the shot images stored in the memory based on the predicted next record point; comparing the extracted shot image with a real time image for matching, aiming to find a matching shot image to a real time image, the real time image being provided from the camera in real time; and acquiring the position data of the record point associated with the matching shot image as the position data of the pedestrian’s current position.

### Effect of the Invention

The present disclosure enables precise positioning of a pedestrian’s current position based on a distance between two adjacent record points. A preliminary image matching operation is performed based on a pedestrian’s movement status to thereby narrow down shot images to be subjected to an image matching operation, which is performed to find a matching shot image to a real time image. As a result, less shot images are subjected to the image matching operation, which enables fast execution of the image matching operation, and also enables reduced processing load on a processor for the image matching operation.

### BRIEF DESCRIPTION OF THE DRAWINGS

FIG. 1 is a diagram showing an overall configuration of a traffic safety assistance system according to a first embodiment of the present disclosure;

FIG. 2 is an explanatory diagram showing a camera 11 of a pedestrian terminal 1 according to the first embodiment;

FIG. 3 is an explanatory diagram showing an outline of an image matching operation performed by the pedestrian terminal 1 according to the first embodiment;

FIG. 4 is an explanatory diagram showing an example of record points (A “record point” refers to a preset point with a pre-shot image record) according to the first embodiment;

FIG. 5 is an explanatory diagram showing an example of stored data in an image-position DB according to the first embodiment;

FIG. 6 is a block diagram showing schematic configurations of the pedestrian terminal 1 and a roadside device 3 according to the first embodiment;

FIG. 7 is a flow chart showing an operation procedure of the pedestrian terminal 1 according to the first embodiment;

FIG. 8 is a flow chart showing an operation procedure of the pedestrian terminal 1 according to the first embodiment;

FIG. 9 is a flow chart showing an operation procedure of an in-vehicle terminal 2 according to the first embodiment;

FIG. 10 is a flow chart showing an operation procedure of a roadside device 3 according to the first embodiment;

FIG. 11 is an explanatory diagram showing an example of stored data in an image-position DB according to a first variant of the first embodiment;

FIG. 12 is a block diagram showing schematic configurations of the pedestrian terminal 1 and the roadside device 3 according to a second variant of the first embodiment;

FIG. 13 is an explanatory diagram showing collection of DB information using a DB information collection terminal 5 according to a second embodiment of the present disclosure;

FIG. 14 is a block diagram showing a schematic configuration of the DB information collection device 5 according to the second embodiment;

FIG. 15 is a flow chart showing an operation procedure of the DB information collection device 5 according to the second embodiment;

FIG. 16 is a block diagram showing a schematic configuration of a roadside device 3 according to a variant of the second embodiment;

FIG. 17 is a flow chart showing an operation procedure of a pedestrian terminal 1 according to a third embodiment of the present disclosure;

FIG. 18 is a diagram showing an overall configuration of a passenger management system according to a fourth embodiment of the present disclosure;

FIG. 19 is an explanatory diagram showing examples of stored data in an image-position DB and a passenger management DB according to the fourth embodiment;

FIG. 20 is a block diagram showing schematic configurations of a pedestrian terminal 1 and a crew terminal 101 according to the fourth embodiment;

FIG. 21 is a flow chart showing an operation procedure of the pedestrian terminal 1 according to the fourth embodiment;

FIG. 22 is a flow chart showing an operation procedure of the crew terminal 101 according to the fourth embodiment;

FIG. 23 is a diagram showing an overall configuration of a customer management system according to a fifth embodiment of the present disclosure;

FIG. 24 is an explanatory diagram showing examples of stored data in an image-position DB and a customer management DB according to the fifth embodiment;

FIG. 25 is a block diagram showing schematic configurations of a pedestrian terminal 1 and a store terminal 111 according to the fifth embodiment;

FIG. 26 is a flow chart showing an operation procedure of the pedestrian terminal 1 according to the fifth embodiment;

FIG. 27 is a flow chart showing an operation procedure of the store terminal 111 according to the fifth embodiment;

FIG. 28 is a diagram showing an overall configuration of a weather information delivery system according to a sixth embodiment of the present disclosure;

FIG. 29 is a block diagram showing schematic configurations of a pedestrian terminal 1 and a roadside device 3 according to the sixth embodiment;

FIG. 30 is a flow chart showing an operation procedure of the pedestrian terminal 1 according to the sixth embodiment;

FIG. 31 is a diagram showing an overall configuration of a facility monitoring system according to a seventh embodiment of the present disclosure;

FIG. 32 is an explanatory diagram showing an example of stored data in an image-position DB according to the seventh embodiment;

FIG. 33 is a block diagram showing schematic configurations of a pedestrian terminal 1 and a facility terminal 131 according to the seventh embodiment; and

FIG. 34 is a flow chart showing an operation procedure of the pedestrian terminal 1 according to the seventh embodiment.

### DESCRIPTION OF THE PREFERRED EMBODIMENT(S)

A first aspect of the present disclosure made to achieve the above-described object is a pedestrian device comprising: a camera for capturing shot images of road surfaces under a pedestrian’s feet; a sensor for detecting a movement of the pedestrian; a memory for storing record information including a shot image of a road surface at a preset record point in association with position data of the record point, the shot image of the record point being preliminarily captured by the camera and stored in the memory; and a processor for performing an image-based positioning operation, wherein the processor performs the image-based positioning operation by predicting a next record point to be reached by the pedestrian based on the pedestrian’s movement status determined from detection results of the sensor; extracting a shot image from the shot images stored in the memory based on the predicted next record point; comparing the extracted shot image with a real time image for matching, aiming to find a matching shot image to a real time image, the real time image being provided from the camera in real time; and acquiring the position data of the record point associated with the matching shot image as the position data of the pedestrian’s current position.

This configuration enables precise positioning of a pedestrian’s current position based on a distance between two adjacent record points. A preliminary image matching operation is performed based on a pedestrian’s movement status to thereby narrow down shot images to be subjected to an image matching operation, which is performed to find a matching shot image to a real time image. As a result, less shot images are subjected to the image matching operation, which enables fast execution of the image matching operation, and also enables reduced processing load on a processor for the image matching operation.

A second aspect of the present disclosure is the pedestrian device of the first aspect, further comprising a communication device configured to communicate with a base station device that maintains record information about a nearby area around the base station device, wherein, when approaching the base station device, the communication device receives record information from the base station device, and wherein, when the communication device receives record information from the base station device, the memory stores the received record information.

In this configuration, the pedestrian device only needs to, when approaching a base station device, receive record information about a nearby area around the base station device, and store the received information in the memory. This feature can reduce communication load on the pedestrian device’s capacity and required memory capacity.

A third aspect of the present disclosure is pedestrian device of the first aspect, wherein, when detecting a specific event in detection results of the sensor, the processor performs an image-based positioning operation to acquire position data of the pedestrian’s current position, and wherein, when detecting no specific event in detection results of the sensor, the processor performs a pedestrian dead reckoning operation using the detection results of the sensor or a satellite positioning, to acquire position data of the pedestrian’s current position.

In this configuration, the pedestrian device performs an image-based positioning operation when detecting a specific event that necessitates the image-based positioning operation, which reduces the frequency of execution of the image-based positioning operation, thereby enabling reduced processing load on a processor for the image matching operation.

A fourth aspect of the present disclosure is the pedestrian device of the third aspect, wherein the specific event includes at least sudden acceleration or sudden change of a moving direction of the pedestrian.

Generally, a sudden increase in a pedestrian’s moving speed (sudden acceleration) or a sudden change of a pedestrian’s moving direction (sudden change of a moving direction) causes a decrease in the reliability of position data acquired by a pedestrian dead reckoning operation. However, in this configuration, the pedestrian device detects such change as a specific event, so that the device can perform the image-based positioning operation, thereby ensuring the precision of position data of the pedestrian’s current position.

A fifth aspect of the present disclosure is an information collection device for collecting the record information to be stored in the pedestrian device of the first aspect, the information collection device comprising: a camera for capturing shot images of road surfaces under a pedestrian’s feet; and a processor configured to set record points on the road in sequence by performing a parallax-based positioning operation to determine a distance between two points on the road surface based on parallaxes in shot images provided from the camera, to thereby collecting record information including the shot image at each record point in association with position data of the record point.

This configuration allows a pedestrian (worker) to collect record information on a target section simply by walking along the section with the information collection device in the pedestrian’s hand. This enables more efficient collection of record information. A parallax-based positioning operation can only provide data of a relative position of the current record point with respect to the previous record point. Thus, the device may be configured such that the positioning operation can provide data of the absolute position (latitude and longitude) of a record point from the origin: that is, the position of the base station device.

A sixth aspect of the present disclosure is s a base station device for providing information to the pedestrian device of the first aspect, the base station device comprising: a memory for storing record information about one or more record points in an area around the base station device, the record information including a shot image of a road surface at each of the record points in association with position data of the record point, the shot image of the record point being preliminarily captured by the camera and stored in the memory; a communication device for communicating with the pedestrian device; and a processor for controlling the communication device so that the base station device delivers the record information to the pedestrian device located nearby.

In this configuration, the pedestrian device only needs to, when approaching a base station device, receive record information about a nearby area around the base station device, and store the received information in the memory. This feature can reduce communication load on the pedestrian device’s capacity and required memory capacity.

A seventh aspect of the present disclosure is a positioning method, wherein the method is performed by a pedestrian device comprising: a camera for capturing shot images of road surfaces under a pedestrian’s feet; a sensor for detecting a movement of the pedestrian; a memory for storing record information including a shot image of a road surface at a preset record point in association with position data of the record point, the shot image being preliminarily captured by the camera and stored in the memory; and a processor, and wherein the processor performs an image-based positioning operation, the image-based positioning operation comprising: predicting a next record point to be reached by the pedestrian based on the pedestrian’s movement status determined from detection results of the sensor; extracting a shot image from the shot images stored in the memory based on the predicted next record point; comparing the extracted shot image with a real time image for matching, aiming to find a matching shot image to a real time image, the real time image being provided from the camera in real time; and acquiring the position data of the record point associated with the matching shot image as the position data of the pedestrian’s current position.

This configuration enables precise positioning of a pedestrian’s current position and also enables fast execution of the image matching operation and also enables reduced processing load on the pedestrian device in the same manner as the first aspect.

An eighth aspect of the present disclosure is a user management method for managing position data of a user carrying the pedestrian device of the first aspect, wherein the memory of the pedestrian device stores record information including a shot image of a road surface at a preset record point in association with position data of the record point, and further with place information, the place information indicating whether or not the record point is included in a specific place, and wherein the processor of the pedestrian device determines whether or not the user is present in the specific place based on the place information corresponding to the record point associated with the matching shot image.

This configuration enables a system performing the method to acquire information indicating whether or not a user is present at or in a specific place. For example, when the specific place is a passenger compartment or a cabin of a vehicle, a system performing the method can confirm a passenger’s presence in the vehicle; that is, check whether or not the passenger is aboard the vehicle.

A ninth aspect of the present disclosure is a user management method for managing data of where a user carrying the pedestrian device of the first aspect is present in a facility, the facility including a plurality of specific areas, wherein the memory of the pedestrian device stores record information including a shot image of a road surface at a preset record point in association with position data of the record point, and further with area ID information, the area ID information indicating in which specific area in the facility the record point is located, and wherein the processor of the pedestrian device identifies the specific area in which the user is present based on the area ID information corresponding to the record point associated with the matching shot image.

This configuration enables a system performing the method to acquire information indicating in which specific area in the facility the user is present. For example, when the specific area is an area where users (customers) are present in order to browse through merchandise items on the shelves, a system performing the method can collect information on the customers’ level of interest in respective items. When the specific area is an area in an entertainment facility where users (customers) are present in order to see amusement attraction, a system performing the method can collect information on the customers’ level of interest in the amusement attraction.

A tenth aspect of the present disclosure is an information collection method for collecting weather information for where the pedestrian device of the first aspect is present, the weather information being collected for a weather information collection device, wherein the memory of the pedestrian device stores record information including a shot image of a road surface at a preset record point in association with position data of the record point, and further with weather information on weather under which the shot image was captured, and wherein the processor of the pedestrian device acquires the weather information corresponding to the record point associated with the matching shot image as weather information on where the pedestrian device is present, and then controls a communication device of the pedestrian device to deliver the acquired weather information to the weather information collection device.

This configuration enables a system performing the method to acquire weather information at each record point. The method may be configured such that a system performing the method can deliver collected weather information to user devices after execution of statistical processing operations as necessary, which enables delivery of weather information area by area.

An eleventh aspect of the present disclosure is a facility monitoring method for detecting a user entering a specific area in a facility, the user carrying the pedestrian device of the first aspect, wherein the memory of the pedestrian device stores record information including a shot image of a road surface at a preset record point in association with position data of the record point, and further with area information, the area information indicating whether the record point is located in the specific area in the facility, and wherein the processor of the pedestrian device determines whether or not the pedestrian has entered the specific area based on the area information corresponding to the record point associated with the matching shot image.

This configuration enables a system performing the method to detect that a user enters a specific area in a facility. The method may be configured such that a system performing the method can provide an alert to a pedestrian when the pedestrian enters a specific area in a facility, which ensures the safety of users of the facility, in particular, visually impaired users.

Embodiments of the present disclosure will be described below with reference to the drawings.

### First Embodiment

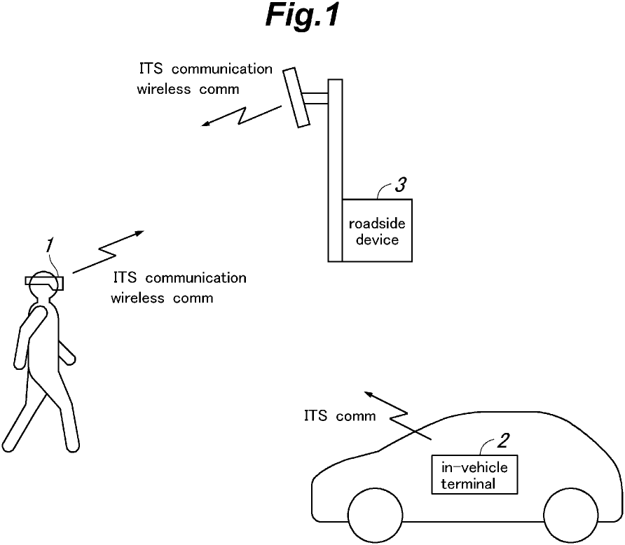

FIG. 1 is a diagram showing an overall configuration of a traffic safety assistance system according to a first embodiment of the present disclosure.

The traffic safety assistance system is configured to assist pedestrian and vehicle traffic safety and includes a pedestrian terminal 1 (pedestrian device), an in-vehicle terminal 2 (in-vehicle device), and a roadside device 3 (roadside device).

The pedestrian terminal 1, the in-vehicle terminal 2, and the roadside device 3 perform ITS communications with each other. ITS communications are performed using frequency bands adopted by ITS-based (i.e., using Intelligent Transport System) safe driving assistance wireless systems (for example, 700 MHz band or 5.8 GHz band). As used herein, “pedestrian-to-vehicle communications” refer to ITS communications performed between the pedestrian terminal 1 and the in-vehicle terminal 2, “roadside-to-pedestrian communications” refer to ITS communications performed between the pedestrian terminal 1 and the roadside device 3, and “roadside-to-vehicle communications” refer to ITS communications performed between the pedestrian terminal 1 and the roadside device 3. In addition, “vehicle-to-vehicle communications” refer to ITS communications performed between different in-vehicle terminals 2.

The pedestrian terminal 1 is carried by a pedestrian. The pedestrian terminal 1 transmits and receives messages including position data to and from the in-vehicle terminal 2 through ITS communications (pedestrian-to-vehicle communication), and determines if there is a risk of collision between the pedestrian and the vehicle. When determining that there is such a risk of collision, the pedestrian terminal 1 provides an alert to the pedestrian. In the embodiment shown in FIG. 1, the pedestrian terminal 1 is a glasses-type wearable device (smart glasses) adapted to be worn on the head of a pedestrian and having functions to provide augmented reality (AR).

The in-vehicle terminal 2 is mounted in a vehicle. The in-vehicle terminal 2 transmits and receives messages including position data to and from the pedestrian terminal 1 through ITS communications (pedestrian-to-vehicle communication), and determines if there is a risk of collision between the pedestrian and the vehicle. When determining there is such a risk of collision, the in-vehicle terminal 2 provides an alert to a driver. An alert is preferably provided by using a car component such as a car navigation device.

The roadside device 3 is installed at a place on or near a road, e.g., at an intersection. The roadside device 3 delivers various types of information, such as traffic information, to the pedestrian terminal 1 and the in-vehicle terminal 2 through ITS communications (roadside-to-pedestrian communications and roadside-to-vehicle communications). The roadside device 3 notifies the in-vehicle terminal 2 and the pedestrian terminal 1 that there are a vehicle and a pedestrian located near the roadside device 3 through ITS communications (roadside-to-vehicle communications, and roadside-to-pedestrian communications), which can prevent a collision at an intersection outside the line of sight.

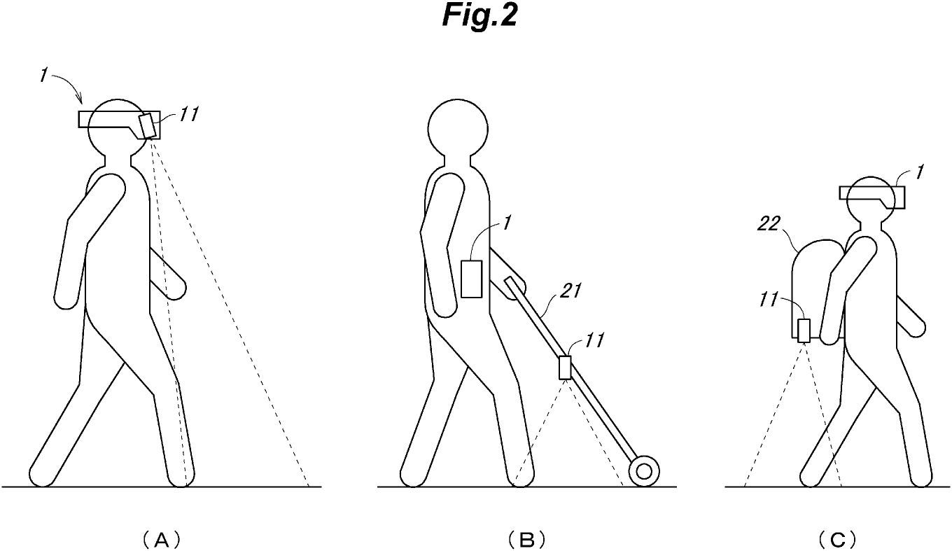

Next, a camera 11 of the pedestrian terminal 1 according to the first embodiment will be described. FIG. 2 is an explanatory diagram showing the camera 11 of the pedestrian terminal 1.

As shown in FIG. 2(A), the pedestrian terminal 1 is equipped with a camera 11. The camera 11 is configured to capture images (shot images) of a road surface under the pedestrian’s feet. The camera 11 is provided with an orientation holding mechanism configured to maintain the proper orientation (shooting angle) of the camera 11 regardless of the tilt of the pedestrian’s head. This feature allows the camera to always acquire a shot image of the road under the pedestrian’s feet even when the pedestrian’s head shakes while the pedestrian is moving, e.g., walking. When the camera 11 shoots directly below the pedestrian, the pedestrian’s body (e.g., legs) may occupy a large portion of a shot image, and the road surface under the pedestrian’s feet may be hidden by the pedestrian’s body. To avoid this, the target orientation of the camera 11 may be adjusted so that its shooting angle is tilted slightly forward.

Examples of orientation holding mechanisms include a structure configured to pivotally support the camera 11 and include a weight to ensure that the camera always faces downward. The orientation holding mechanism may include a spring configured to reduce the horizontal sway of the camera 11 occurred due to the tilt of the pedestrian’s head and the vertical sway of the camera 11 occurred due to the pedestrian’s walking. The orientation holding mechanism may include a structure including an actuator for controlling the orientation of the camera 11 so as to reduce the sway of the camera 11, based on the detection results of a gyro sensor for detecting the orientation of the camera 11.

In an example shown in FIG. 2(A), the pedestrian terminal 1 is a glasses-type wearable device (what is called “smart glasses”). An AR display of the pedestrian terminal 1 displays virtual objects overlaid on the real space view of a user’s actual field of vision, thereby implementing augmented reality (AR). The AR display shows, as virtual objects, an image that indicates a risk of collision with vehicles and an image of a vehicle that is not directly visible to the pedestrian at an out-of-sight intersection. The pedestrian terminal 1 may be comprised primarily of a head-mounted part worn on a user’s head and a body part carried by the user.

In an example shown in FIG. 2(B), the camera 11 is provided on a white cane 21 with wheels used by a visually impaired person, so that the camera can capture shot images of a road surface under a walking pedestrian. In this case, the orientation holding mechanism may be provided to properly hold the orientation (shooting angle) of the camera 11. This configuration is convenient for the visually impaired. The white cane 21 with wheels has less vertical movement than a typical white cane, and provides an advantage that the camera 11 is less likely to sway up and down.

In an example shown in FIG. 2(C), the camera 11 is attached to a school bag 22 that the pedestrian (child) carries on the back so that the camera 11 can capture shot images of road surfaces under the pedestrian’s foot on the rear side during walking. In this case, the camera 11 is preferably attached on the underside or rear side of the school bag 22. In this configuration, the camera 11 is positioned away from the pedestrian’s body, which prevents the pedestrian’s body from hiding a large part of the road surface in a shot image.

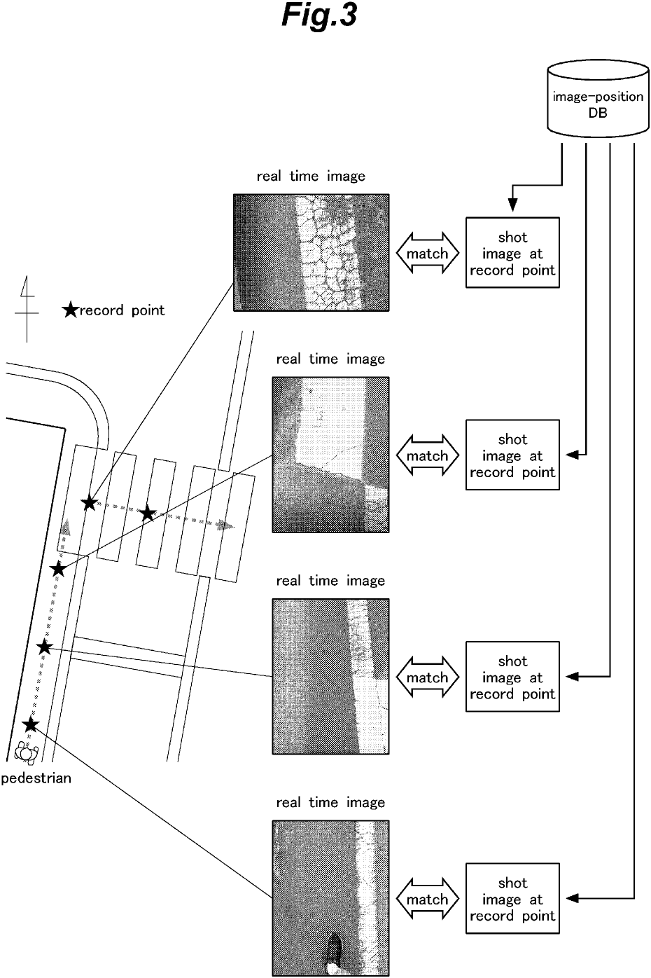

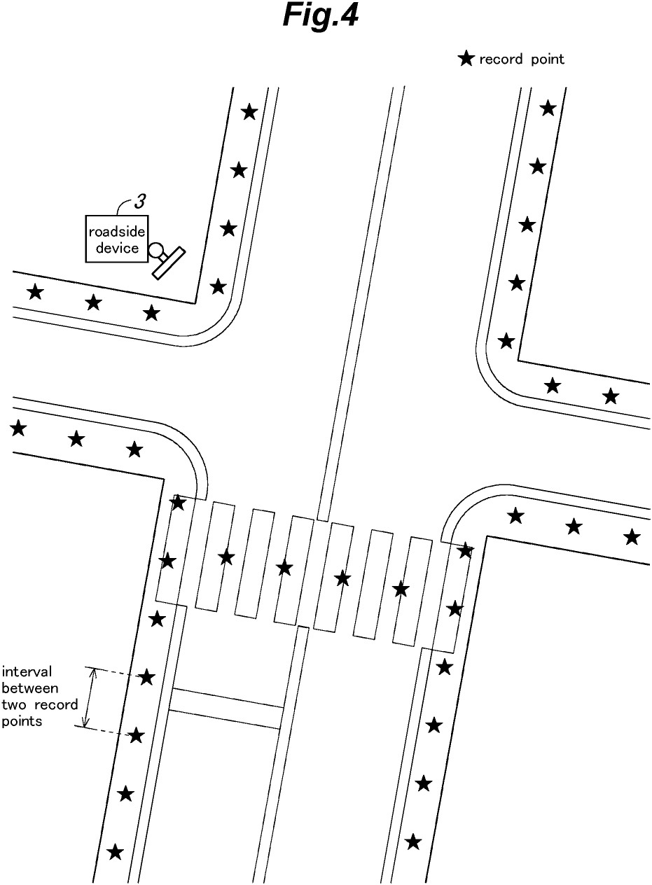

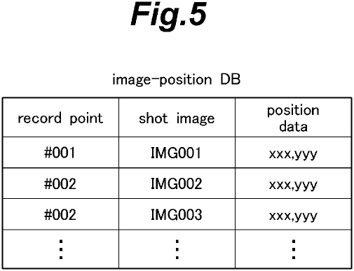

Next, an outline of an image matching operation performed by the pedestrian terminal 1 according to the first embodiment will be described. FIG. 3 is an explanatory diagram showing an outline of the image matching operation performed by the pedestrian terminal 1. FIG. 4 is an explanatory diagram showing an example of record points (As used herein, a record point refers to a preset point with a pre-shot image record), and FIG. 5 is an explanatory diagram showing an example of stored data in an image-position DB (database).

Road surfaces gradually deteriorate over time. For example, road surface markings such as white lines are painted on road surfaces using special paint (traffic paint), and cracks and other deterioration occur on the road markings over time. In addition, asphalt pavement material also deteriorates due to defects. The fact that these deteriorated road surfaces have unique characteristics at each location enables use of a shot image to identify a location (position) where the shot image was captured, based on the characteristics of the road surface.

In the present embodiment, an image-position DB (database) is prepared in the roadside device 3 beforehand such that the image-position DB contains a shot image of a road surface at each record point, in association with the position data of the record point (see FIG. 5). When the pedestrian terminal 1 is used, the camera 11 captures a shot image of a road surface under a pedestrian’s feet and outputs the shot image in real time. Herein, the shot image output from the camera 11 in real time is also written as a “real time image.” In addition, as shown in FIG. 3, the pedestrian terminal 1 performs an image matching operation. Specifically, the pedestrian terminal 1 compares a shot image of each record point in the image-position DB with the real time image provided from the camera 11 for matching, and when finding a matching shot image to a real time image, the pedestrian terminal 1 acquires the position data associated with the matching shot image as the position data of the pedestrian’s current position.

In the present embodiment, as shown in FIG. 4, when the roadside device 3 is installed at an intersection, a target area for which the image-position DB contains data is a nearby area around the intersection at which the roadside device 3 is installed (More specifically, an area including the intersection where the roadside device 3 is installed and a predetermined range of each road segment connected to the intersection). Record points are preset within this target area such that adjoining pairs of record points are located at predetermined intervals (e.g., 25 cm). Since pedestrians usually pass through a pedestrian crossing at the intersection, or move down on sidewalks or roadside strips of the roads connected to the intersection, record points are preset in such an area where pedestrians are likely to pass through.

Thus, as shown in FIG. 3, while a pedestrian is walking to pass through a pedestrian crossing at an intersection or on a sidewalk or roadside strip, the camera 11 periodically outputs a real time image of a road surface under the pedestrian’s feet and the pedestrian terminal 1 performs the image matching operation. When the pedestrian reaches a record point and a matching shot image is found, the pedestrian terminal 1 can identify the current position of the pedestrian based on the position data associated with the matching shot image.

The pedestrian terminal 1 can perform the image matching operation, which enables determination of a moving direction of a pedestrian (i.e., the direction in which the pedestrian is moving). Specifically, when the image-position DB contains the orientation of the shot image, for example, the orientation of the upper side of the shot image (east, west, north, or south), the pedestrian terminal 1 performs the image matching operation to thereby rotate the shot image in the image-position DB so as to match the orientation of the shot image to that of the real time image provided from the camera 11, thereby determining the orientation of the upper side of the real time image; that is, the pedestrian’s moving direction.

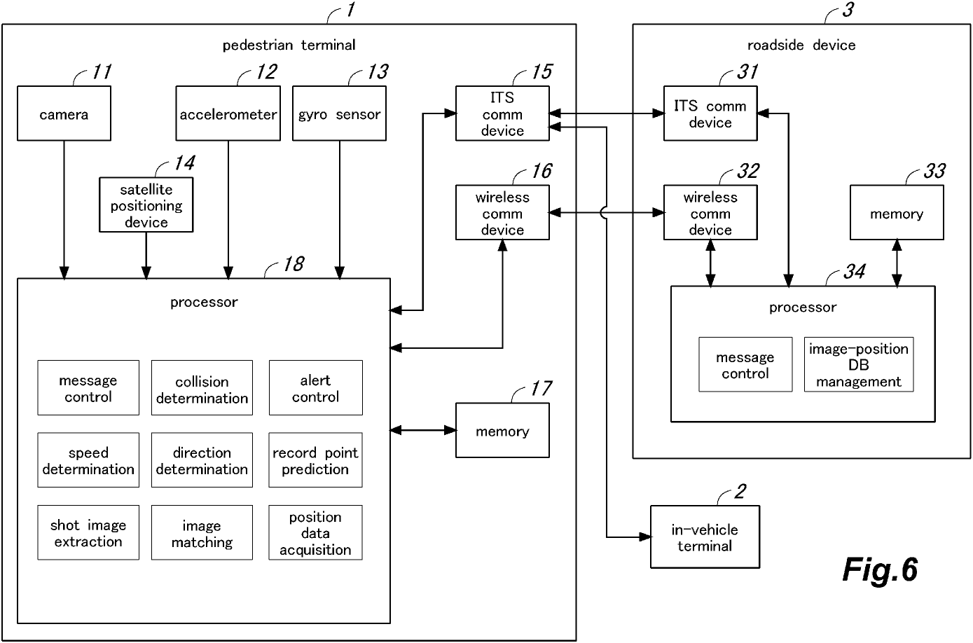

In the present embodiment, the pedestrian terminal 1 performs a preliminary image matching operation, which includes: (i) predicting the record point where the pedestrian is to reach next based on the data of the previous record point where the image matching operation was performed and the pedestrian’s movement status determined from the detection results of an accelerometer 12 and a gyro sensor 13 (see FIG. 6); (ii) extracting one or more shot images to be subjected to an image matching operation from those in the image-position DB based on the prediction result, and (iii) comparing each extracted shot image with the real time image output from the camera 11 for matching (i.e., searching for a matching shot image to a real time image).

In the present embodiment, the pedestrian terminal 1 determines, as the pedestrian’s movement status, the pedestrian’s moving direction based on the detection results of the gyro sensor 13, and the pedestrian’s moving speed based on the detection results of the accelerometer 12; and then predicts the next record point which the pedestrian is to reach, based on the pedestrian’s moving direction and moving speed. In other embodiments, the pedestrian terminal 1 may predict the next record point the pedestrian is to reach based only on the pedestrian’s moving direction. In this case, the record point located ahead of the pedestrian’s moving direction is selected as a predicted next record point that the pedestrian is to reach.

The preliminary image matching operation described above includes predicting the next record point the pedestrian is to reach based on the pedestrian’s movement status. In other embodiments, the pedestrian terminal 1 may perform a pedestrian dead reckoning (PDR) operation to estimate the pedestrian’s current position, and predict the next record point the pedestrian is to reach based on the estimated position.

In this way, in the present embodiment, the preliminary image matching operation is performed based on a pedestrian’s movement status to thereby narrow down shot images to be subjected to the image matching operation from those in the image-position DB. As a result, less shot images are subjected to the image matching operation, which can achieve fast execution of the image matching operation, and also enables reduced processing load on a processor for the image matching operation.

Next, schematic configurations of the pedestrian terminal 1 and the roadside device 3 according to the first embodiment will be described. FIG. 6 is a block diagram showing the schematic configurations of the pedestrian terminal 1 and the roadside device 3.

A pedestrian terminal 1 includes a camera 11, an accelerometer 12, a gyro sensor 13, a satellite positioning device 14, an ITS communication device 15, a wireless communication device 16, a memory 17, and a processor 18. When the pedestrian terminal 1 is a glasses-type wearable device (smart glasses), the pedestrian terminal 1 is equipped with an AR display (not shown).

The camera 11 captures shot images of surfaces under the pedestrian’s feet.

The accelerometer 12 detects an acceleration of the pedestrian’s body. The gyro sensor 13 detects the angular velocity of the pedestrian’s body. The pedestrian terminal 1 may be provided with other motion sensors.

The satellite positioning device 14 determines the position of the pedestrian terminal 1 by using a satellite positioning system such as GPS (Global Positioning System) or QZSS (Quasi-Zenith Satellite System), to thereby acquire the position data (latitude, longitude) of the pedestrian terminal 1.

The ITS communication device 15 broadcasts (delivers) messages to an in-vehicle terminal 2 and a roadside device 3 through ITS communications (vehicle-to-vehicle and road-to-vehicle communications), and also receives messages transmitted from the in-vehicle terminal 2 and the roadside device 3.

The wireless communication device 16 transmits and receives messages to and from the roadside device 3 through wireless communications such as WiFi (Registered Trademark).

The memory 17 stores map data, programs executable by the processor 18, and other information. In the present embodiment, the memory 17 stores record information contained in the image-position DB, i.e., the shot image and position data for each record point. Moreover, in the present embodiment, when approaching an intersection, the pedestrian terminal 1 acquires, from a roadside device 3 installed at the intersection, the record information in the image-position DB for the nearby area around the intersection.

The processor 18 performs various processing operations by executing the programs stored in the memory 17. In the present embodiment, the processor 18 performs a message control operation, a collision determination operation, an alert control operation, a speed determination operation, a direction determination operation, a record point prediction operation, a shot image extraction operation, an image matching operation, and a position data acquisition operation.

In the message control operation, the processor 18 controls the transmission of messages through ITS communications (hereafter also written as “ITS communication messages”) between the in-vehicle terminal 2 and the roadside device 3. The processor 18 also controls the transmission of messages through wireless communication (hereafter also written as “wireless communication messages”) between the pedestrian terminal 1 and the roadside device 3.

In the collision determination operation, the processor 18 determines whether or not there is a risk of collision between a vehicle and the pedestrian based on the vehicle position data included in the vehicle information acquired from the in-vehicle terminal 2, and the pedestrian position data acquired by the satellite positioning device 14.

In the alert control operation, the processor 18 controls provision of a prescribed alert (e.g., voice output or vibration) to the pedestrian in response to determining that there is a risk of collision in the collision determination operation.

In the speed determination operation, the processor 18 determines the pedestrian’s moving speed based on the detection results of the accelerometer 12. When a pedestrian walks, the pedestrian’s body produces acceleration, and the processor 18 can determine the walking pitch (duration for a complete footstep) of the pedestrian based on the change of the acceleration. Then, the processor 18 calculates the moving speed from the pedestrian’s walking pitch and stride length. The stride length may be determined based on the attribute of the pedestrian (such as adult or child) stored in the pedestrian terminal 1.

In the direction determination operation, the processor 18 determines the pedestrian’s moving direction based on the detection results of the gyro sensor 13.

In the record point prediction operation, the processor 18 predicts the next record point that the pedestrian is to reach based on the pedestrian’s current position data, the moving speed, and the moving direction. The processor 18 can perform the record point prediction operation when the pedestrian reaches a record point and the processor acquires the position data of the pedestrian’s current position through the image-based positioning operation.

In the shot image extraction operation, the processor 18 extracts one or more shot images to be subjected to the image matching operation from the image-position DB of the pedestrian terminal 1 based on the predicted record point. Although this operation can be done based on a shot image of a predicted record point, the processor 18 may extract shot images of multiple record points within a predetermined area around the predicted record point. When the record point prediction operation determines multiple predicted record points that the pedestrian may reach next, the processor 18 may extract the respective shot images of the multiple predicted record points.

In the image matching operation, the processor 18 compares the shot image of a record point extracted during the shot image extraction operation, with a real time image provided from the camera 11 for matching. Specifically, the processor 18 extracts feature data (information on feature points) from the real time image and the shot image of a record point, respectively, and compares each feature data with a corresponding feature data for matching, to thereby find a matching shot image to a real time image. In some cases, the processor 18 may perform the image matching operation using AI (artificial intelligence) technology.

In the position data acquisition operation, the processor 18 acquires the position data of a record point associated with a matching shot image found in the image matching operation, as the position data of the pedestrian’s current position.

The in-vehicle terminal 2 also includes a processor and a memory (not shown), and is capable of performing a message control operation, a collision determination operation, and an alert control operation by executing programs stored in the memory.

The roadside device 3 includes an ITS communication device 31, a wireless communication device 32, a memory 33, and a processor 34.

The ITS communication device 31 broadcasts (delivers) messages to a pedestrian terminal 1 and an in-vehicle terminal 2 through ITS communications (road-to-pedestrian and road-to-vehicle communications), and also receives messages transmitted from the pedestrian terminal 1 and the in-vehicle terminal 2.

The wireless communication device 32 transmits and receives messages to and from the pedestrian terminal 1 through wireless communications such as WiFi (Registered Trademark).

The memory 33 stores programs that are executable by the processor 34, and other information. In the present embodiment, the memory 33 stores the record information in the image-position DB (see FIG. 5), i.e., a shot image and position data for each record point.

The processor 34 performs various processing operations by executing the programs stored in the memory 33. In the present embodiment, the processor 34 performs a message control operation and an image-position DB management operation.

In the message control operation, the processor 34 controls the transmission of ITS communication messages between the pedestrian terminal 1 and the in-vehicle terminal 2. The processor 34 also controls the transmission of wireless communication messages between the pedestrian terminal 1 and the roadside device 3.

In the image-position DB management operation, the processor 34 manages the image-position DB (see FIG. 5). The image-position DB contains a shot image and position data for each record point. In the present embodiment, such record information in the image-position DB is delivered to the pedestrian terminal 1 upon request from the pedestrian terminal 1.

Examples of methods for collecting record information in the image-position DB are not limited to, but include a DB information collection method of a second embodiment described later.

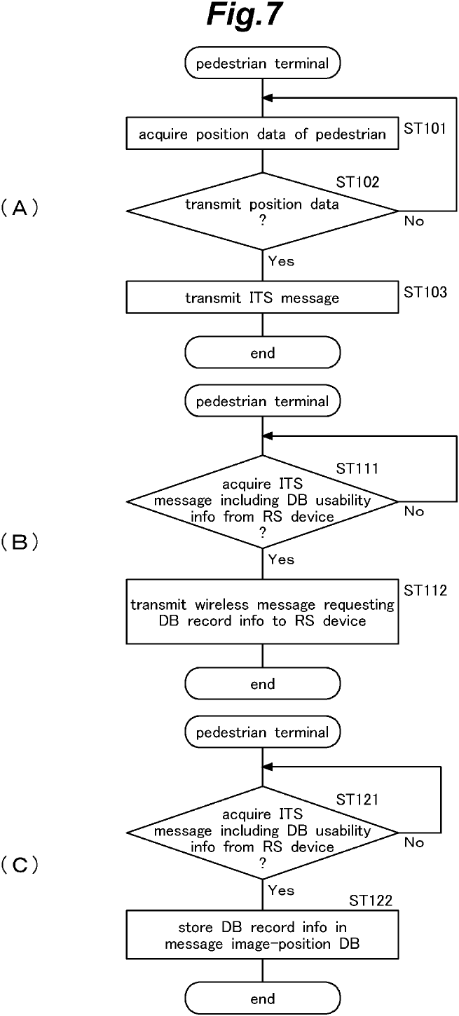

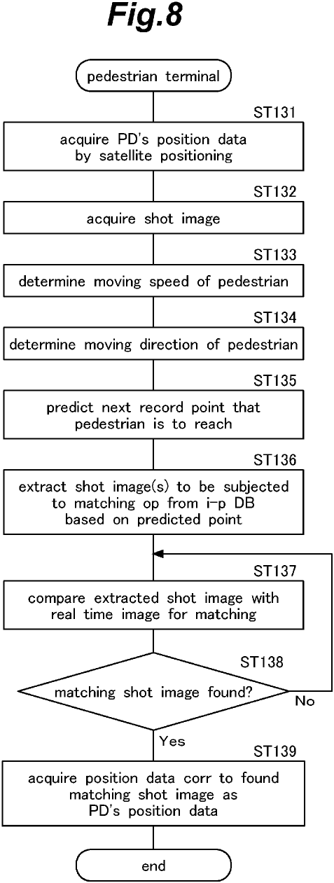

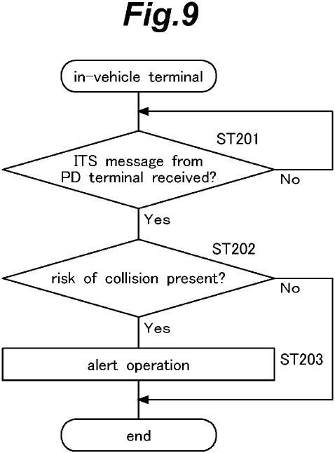

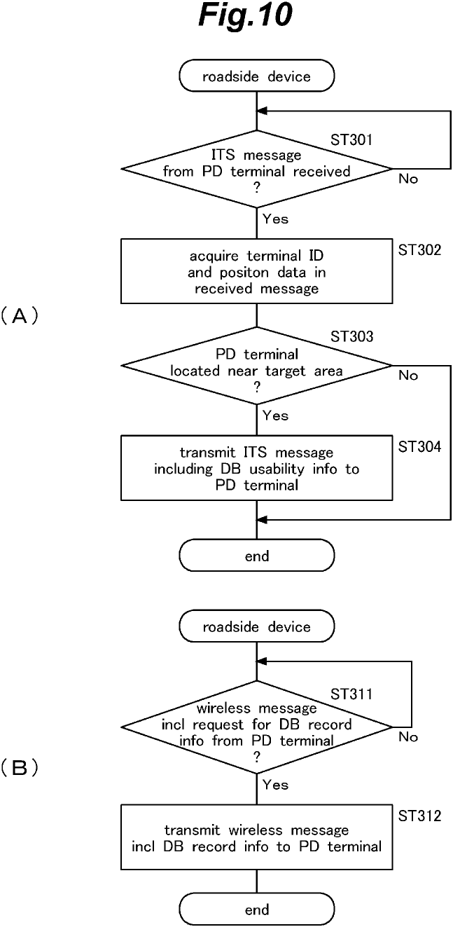

Next, operation procedures of the pedestrian terminal 1, the in-vehicle terminal 2, and the roadside device 3 of the first embodiment will be described. FIGS. 7 and 8 are flow charts showing operation procedures of the pedestrian terminal 1. FIG. 9 is a flow chart showing an operation procedure of the in-vehicle terminal 2. FIG. 10 is a flow chart showing an operation procedure of the roadside device 3.

As shown in FIG. 7(A), in the pedestrian terminal 1, the satellite positioning device 14 first acquires a pedestrian’s position data (ST101). Next, the processor 18 determines, based on the pedestrian’s position data, whether or not pedestrian information should be transmitted, specifically, whether or not a user has entered a dangerous area (ST102).

When pedestrian information should be transmitted to other devices (Yes in ST102), in response to a transmission instruction provided from the processor 18, the ITS communication device 15 transmits an ITS communication message containing the pedestrian information (such as pedestrian’s ID and position data) to the in-vehicle terminal 2 and the roadside device 3 (ST103).

As shown in FIG. 9, when the in-vehicle terminal 2 receives the ITS communication message (through pedestrian-to-vehicle communications) from the pedestrian terminal 1 (Yes in ST201), the in-vehicle terminal 2 performs the collision determination operation based on the position data of the vehicle and other information included in the message, to thereby determine whether or not there is a risk that the vehicle may collide with a pedestrian (ST202).

When determining that there is a risk of collision (Yes in ST202), the in-vehicle terminal 2 performs a predetermined alert operation for a driver (ST203). Specifically, the in-vehicle terminal 2 causes the in-vehicle navigation system to provide an alert (e.g., sound output or screen display) to the driver. When the vehicle is an autonomous vehicle, the in-vehicle terminal 2 instructs an autonomous driving ECU (travel control device) to perform a predetermined collision avoidance operation.

As shown in FIG. 10(A), in the roadside device 3, when the ITS communication device 31 receives an ITS communication message (through vehicle-to-pedestrian communications) from the pedestrian terminal 1 (Yes in ST301), the processor 34 acquires the terminal ID and position data of the pedestrian terminal 1 included in the received message (ST302). Next, the processor 34 determines, based on the pedestrian’s position data, whether or not the pedestrian terminal 1 is located near a target area (within or around the target area), for which the image-position DB contains record information (ST303).

When determining that the pedestrian terminal 1 is located near the target area (Yes in ST303), the processor 34 provides a transmission instruction, causing the ITS communication device 31 to transmit an ITS communication message including DB usability information to the pedestrian terminal 1, where the DB usability information indicates that the record information in the image-position DB in the roadside device 3 is usable by the pedestrian terminal 1 (ST304).

As shown in FIG. 7(B), in the pedestrian terminal 1, when the ITS communication device 15 receives the ITS communication message including DB usability information from the roadside device 3 (Yes in ST111), the processor 18 provides a transmission instruction, causing the wireless communication device 16 to transmit a wireless communication message requesting DB record information (record information in the image-position DB) to the roadside device 3 (ST 112).

As shown in FIG. 10(B), in the roadside device 3, when the wireless communication device 32 receives the wireless communication message requesting DB record information from the pedestrian terminal 1 (Yes in ST311), the processor 34 provides a transmission instruction, causing the wireless communication device 32 to transmit a wireless communication message including DB record information (record information in the image-position DB) to the pedestrian terminal 1 (ST312).

In this step, the roadside device 3 may transmit all record information in the image-position DB to the pedestrian terminal 1, or transmit only part of record information that is likely to be used by the pedestrian terminal 1 to the pedestrian terminal 1. Specifically, the roadside device 3 may transmit record information associated with record points within a predetermined area near the pedestrian terminal 1, in particular the record points within a predetermined range located along the path in the pedestrian’s moving direction.

As shown in FIG. 7(C), in the pedestrian terminal 1, when the wireless communication device 16 receives the wireless communication message including DB record information from the roadside device 3 (Yes in ST121), the processor 18 stores the DB record information (record information in the image-position DB) included in the received message, in the image-position DB of the pedestrian terminal 1 (ST122).

Next, as shown in FIG. 8, in the pedestrian terminal 1, the processor 18 acquires the position data of the pedestrian’s position by using the satellite positioning device 14 (ST 131). The processor 18 also acquires a real time image of a road surface under the pedestrian’s feet captured by the camera 11 (ST132). Furthermore, the processor 18 determines the moving speed of the pedestrian based on the detection results of the accelerometer 12 (ST133), and determines the pedestrian’s moving direction based on the detection results of the gyro sensor 13 (ST134).

Next, the processor 18 performs the record point prediction operation; that is, predicts the next record point that the pedestrian is to reach, based on the position data of the pedestrian’s current position, and the pedestrian’s moving speed and moving direction (ST135).

Next, the processor 18 performs the shot image extraction operation; that is, extracts the shot images to be subjected to the image matching operation from those in the image-position DB of the pedestrian terminal 1, based on the predicted record point (ST136).

Next, the processor 18 performs an image matching operation; that is, compares the shot image extracted from those in the image-position DB with the real time image provided from the camera 11 for matching, aiming to find a matching shot image to a real time image (ST137).

When a matching image to a real image is successfully found, specifically, a matching shot image to a real time image is found in the image matching operation performed on the image-position DB, (Yes in ST138), then the processor 18 performs a position data acquisition operation to acquire position data of the record point associated with the matching shot image, as the position data of the pedestrian’s current position (ST139).

In the present embodiment, the roadside device 3 provides a shot image of a record point to the pedestrian terminal 1, which performs the image matching operation. In other embodiments, the roadside device 3 may transmit feature information (information on feature points) extracted from a shot image of a record point, to the pedestrian terminal 1. In this case, the pedestrian terminal 1 performs the image matching operation by comparing the feature information on the record point transmitted from the roadside device 3 with the corresponding feature information extracted from the real time image. In other cases, the roadside device 3 may cut out a feature part of the shot image of the record point and provide the feature part image to the pedestrian terminal 1, so that the pedestrian terminal 1 can perform the image matching operation using the feature part image. This configuration decreases the amount of record information in the image-position DB that is required to be transmitted from the roadside device 3 to the pedestrian terminal 1, thereby enabling reduced communication load on processing capacities of the roadside device 3 and the pedestrian terminal 1 during wireless communications therebetween.

In some cases, the system may be configured such that all communication links between the roadside device 3 and the pedestrian device 4 are those for cellular communications and all the functions of a roadside device 3 are stored in the cloud, enabling management of an image-position DB for a wider area.

### (First Variant of First Embodiment)

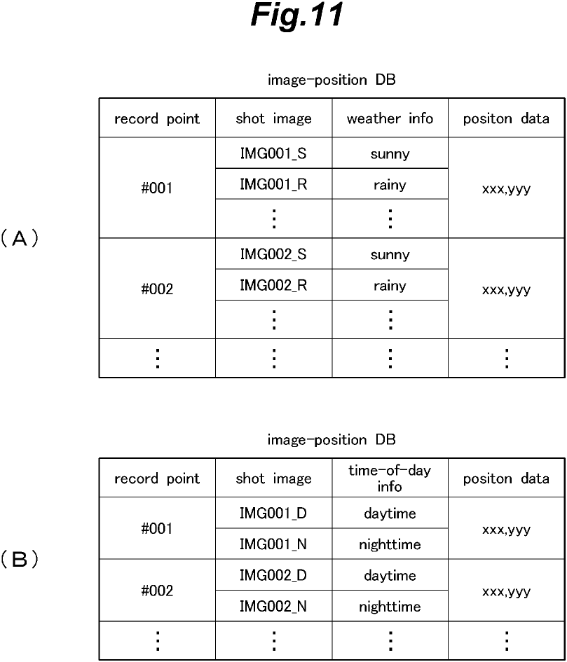

Next, an image-position DB according to a first variant of the first embodiment will be described. Except for what will be discussed here, the first variant is the same as the above-described embodiment. FIG. 11 is an explanatory diagram showing an example of stored data in an image-position DB according to the first variant of the first embodiment.

The condition of a road surface under the pedestrian’s feet varies with changes in the environment. For example, in rainy or snowy weather, the road surface becomes wet or snow-covered, which are quite different conditions from those in fine weather or a cloudy weather. In the case of nighttime, the road surface is in a dark condition, which differs significantly from that in daytime.

In the present embodiment, shot images of road surfaces under the pedestrian’s feet are collected in different weather conditions (such as sunny, rainy, or snowy), and shot images in the respective weather conditions are recorded in the image-position DB by weather (see FIG. 11(A)). When comparing a shot image of a record point in the image-position DB with a real time image for matching, the pedestrian terminal 1 refers to shot images in different weathers for one record point, and uses a shot image of each weather condition in comparison for matching.

In the present embodiment, shot images of road surfaces under the pedestrian’s feet are collected in each period of time (such as daytime or nighttime), and the collected shot images are recorded in the image-position DB by period of time (see FIG. 11(B)). When comparing a shot image of a record point in the image-position DB with a real time image for matching, the pedestrian terminal 1 refers to shot images in different periods of time for one record point, and uses a shot image of each period of time in comparison for matching.

In this way, in this first variant of the first embodiment, a shot image in each of the different environmental conditions (such as weather and time of day) is compared with a real time image for matching. This configuration can prevent the variation of the road surface condition caused by different environmental conditions, from affecting the image matching operation.

In the first variant, shot images in the respective periods of time are recorded in the image-position DB by period of time (see FIG. 11(B)). In other embodiments, the pedestrian terminal 1 may be provided with a light to illuminate the road surface under the pedestrian’s feet, thereby preventing the difference in the brightness of a road surface depending on the time of day from affecting the image matching operation.

### (Second Variant of First Embodiment)

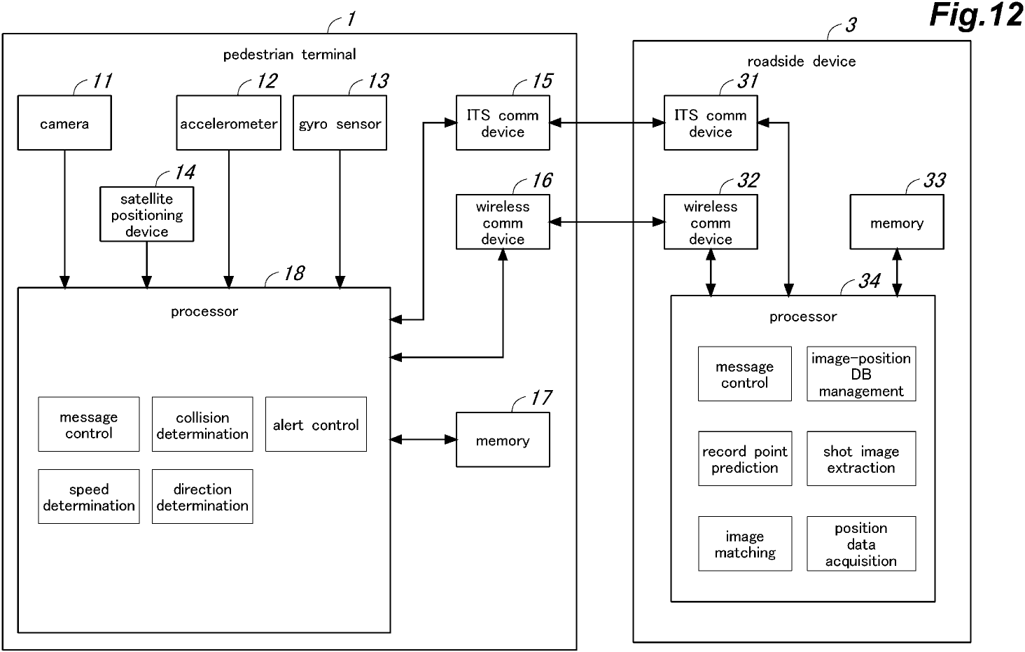

Next, devices according to a second variant of the first embodiment will be described. Except for what will be discussed here, the second variant is the same as the above-described embodiment. FIG. 12 is a block diagram showing schematic configurations of a pedestrian terminal 1 and a roadside device 3 according to the second variant of the first embodiment.

In the first embodiment, the pedestrian terminal 1 performs the image-based positioning operation.

In this second variant, the roadside device 3 performs the image-based positioning operation.

Specifically, the pedestrian terminal 1 transmits necessary information to the roadside device 3 via wireless communications, the necessary information comprising (i) position data of a pedestrian’s current position acquired from the satellite positioning device 14, (ii) a real time image provided from the camera 11, and (iii) information on the pedestrian’s moving speed and moving direction.

In the roadside device 3, the processor 34 first performs the record point prediction operation; that is, predicts the next record point that the pedestrian is to reach, based on the position data of the pedestrian’s current position and the pedestrian’s moving speed and moving direction.

Next, the processor 34 performs the shot image extraction operation based on the predicted record point; that is, extracts one or more shot images to be subjected to the image matching operation from the image-position DB of the roadside device 3.

Next, the processor 34 performs the image matching operation; that is, compares a real time image acquired from the pedestrian terminal 1 with a shot image extracted from the roadside device’s image-position DB for matching.

When a matching shot image is found in the image matching operation; that is, when a shot image extracted from the image-position DB of the roadside device is a matching shot image to the real time image, the processor 34 performs the position data acquisition operation to acquire the position data of the record point associated with the matching shot image as the position data of the pedestrian’s current position.

Next, in response to a transmission instruction provided from the processor 34, the wireless communication device 32 transmits the position data of the pedestrian’s current position to the pedestrian terminal 1.

In this way, in this second variant of the first embodiment, the roadside device 3 performs the image-based positioning operation, which enables reduced processing load on a processor 18 for the image matching operation. This configuration also enables a reduction in power consumption of the pedestrian terminal 1.

In this way, in this second variant of the first embodiment, the roadside device 3 may always perform the image-based positioning operation. However, in other cases, the roadside device 3 may be configured such that, under a normal condition, the pedestrian terminal 1 performs the image-based positioning operation, and the roadside device 3 performs the image-based positioning operation only under a specific condition, e.g., only when the battery capacity of the pedestrian terminal 1 is low.

In other embodiments, the roadside device 3 may perform the image-based positioning operation only when a pedestrian carrying the pedestrian terminal 1 has a specific attribute. For example, when the pedestrian is an elderly person, it is preferable that the pedestrian terminal 1 has less power consumption to minimize the frequency of a requirement of charging the battery. Thus, the roadside device 3 may be configured to perform the image-based positioning operation when a pedestrian carrying the pedestrian terminal 1 is an elderly person.

### Second Embodiment

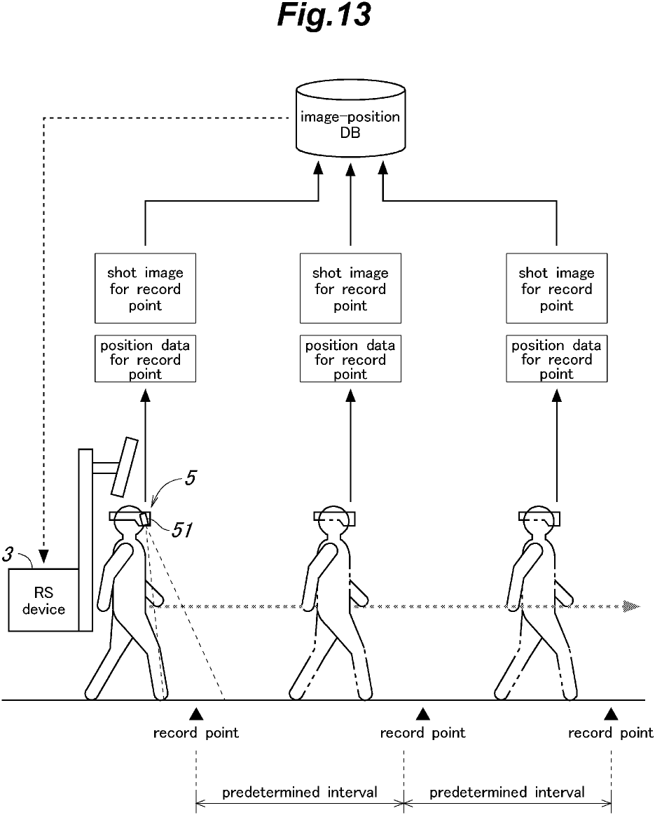

Next, a system for collecting DB information according to a second embodiment of the present disclosure will be described. FIG. 13 is an explanatory diagram showing collection of DB information using a DB information collection terminal 5 according to the second embodiment.

The system of present embodiment collects record information to be stored in the image-position DB in the roadside device 3 by using a DB information collection terminal 5 (information collection device). Specifically, the system collects shot images of road surfaces at record points and corresponding position data of the record points.

The DB information collection terminal 5 is equipped with a camera 51 in a similar manner to the pedestrian terminal 1 of the first embodiment (see FIG. 2). This camera 51 can capture moving images of road surfaces under the pedestrian’s feet and outputs a shot image (frame) at each time point. The DB information collection terminal 5 extracts, from these shot images captured at the time points, shot images of road surfaces at present record points and stores the extracted shot images in the image-position DB.

Specifically, as shown in FIG. 13, a worker (pedestrian) carrying a DB information collection terminal 5 walks along a target area (sidewalks, pedestrian crossings, or roadside strips) around the roadside device 3, during which the DB information collection terminal 5 collects record information to be stored in the image-position DB, i.e., shot images of road surfaces at record points and the position data of the record points in sequence. The shot images and position data for each record point collected by the DB information collection terminal 5 are stored in the image-position DB in the roadside device 3.

In the present embodiment, record points at which acquired shot image and position data are to be stored in the image-position DB are preset at predetermined intervals (e.g., 25 cm intervals) on the road surface in the target area (see FIG. 4). Specifically, a next record point is located at a predetermined interval from the previous record point. Then, the DB information collection terminal 5 performs a parallax-based positioning operation to determine the distance between two adjoining points on the road surface, thereby determining the next record point using the previous record point as a base point.

In the parallax-based positioning operation, the DB information collection terminal 5, for each shot image (frame) provided from the camera 11 at each time, detects the parallax generated by a change in the shooting position of the camera 11, and then, based on the parallax, the DB information collection terminal 5 acquires 3D information records of road surfaces (in a plane) under the feet, using the position of the camera 11 as a reference point, which enables the DB information collection terminal 5 to determine the distance between the camera 11 to the road surface from the acquired 3D information records, thereby calculating the distance between two points on the road surface under the worker’s feet based on the principle of three-point surveying.

The DB information collection terminal 5 acquires position data of a next record point based on the position data of the previous record point, the interval between the two adjoining record points, and the worker’s moving direction.

The accuracy of the image-based positioning operation can change depending on the interval of two adjoining record points. A decrease in the interval between two adjoining record points can improve the accuracy of the image-based positioning operation. For example, when the interval between adjoining record points is 25 cm, which is half of the human’s standard stride length of 50 cm, the accuracy of the image-based positioning operation becomes 25 cm.

In the present embodiment, record points, where shot images and position data are acquired to be stored in the image-position DB, are preset using the installation point of the roadside device 3 as a base point. Thus, the worker carrying the DB information collection terminal 5 can start walking from a location close to the roadside device 3. In this case, the DB information collection terminal 5 collects shot images and position data of record points in order from a record point near roadside device 3. For example, when the roadside device 3 is located at the corner of an intersection, the worker may walk away from the roadside device 3 such that the worker passes through a pedestrian crossing at the intersection, or move down on a sidewalk or roadside strip of a road connected to the intersection.

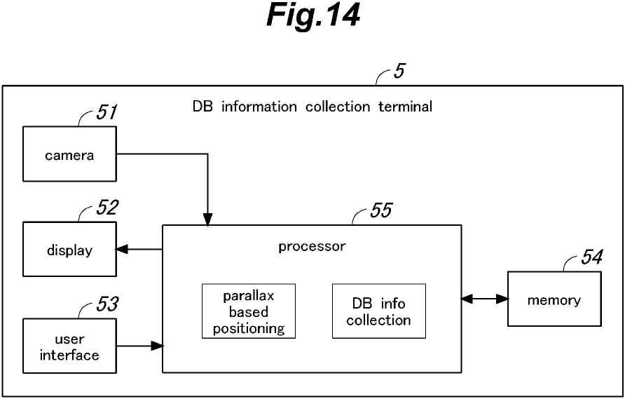

Next, a schematic configuration of the DB information collection device 5 according to the second embodiment will be described. FIG. 14 is a block diagram showing a schematic configuration of the DB information collection device 5.

The DB information collection terminal 5 includes a camera 51, a display 52, a user interface 53, a memory 54, and a processor 55.

The camera 51 captures shot images of road surfaces under the pedestrian’s feet.

The display 52 displays various operation screens. The user interface 53 detects a user’s input operation.

The memory 54 stores programs that are executable by the processor 55, and other information.

The processor 55 performs various processing operations by executing the programs stored in the memory 54. In the present embodiment, the processor 55 performs a parallax-based positioning operation, and a DB information collection operation.

In the parallax-based positioning operation, the processor 55, for each shot image (frame) provided from the camera 51 at each time, detects the parallax generated by a change in the shooting position of the camera 51, and then, based on the parallax, the processor 55 acquires 3D information records of the road surface (plane) under the feet, using the position of the camera 51 as a reference point, which enables the processor 55 to determine the distance between the camera 51 to the road surface based on the acquired 3D information records, thereby calculating the distance between two points on the road surface under the worker’s feet based on the principle of three-point surveying.

In the DB information collection operation, the processor 55 extracts a shot image of each record point from images (frames) provided in sequence from the camera 51 at times, and stores the shot image in association with the position data of a first record point in the memory. In the DB information collection operation, the processor 55 calculates the position data (latitude and longitude) of a record point based on the distance between two points acquired in the parallax-based positioning operation, using the position (latitude and longitude) of the installation point of the roadside device 3 as a base point.

In the example shown in FIG. 13, the DB information collection terminal 5 is a glasses-type wearable device (smart glasses). However, the DB information collection terminal 5 may be a smartphone. In this case, an application for collecting DB information is installed on the smartphone. The camera 51 for capturing shot images of road surfaces under the worker’s feet, is attached to the worker’s body part (e.g., head). The camera 51 is connected to the smartphone via a wireless or wired communication link, and can transmit shot images of road surfaces to the smartphone.

In the present embodiment, a worker (user) enters the position data (latitude and longitude) of the installation point of the roadside device 3 through the user interface 53. However, the DB information collection terminal 5 may acquire the position data of the installation point from the roadside device 3 through communications such as ITS communications or wireless communications.

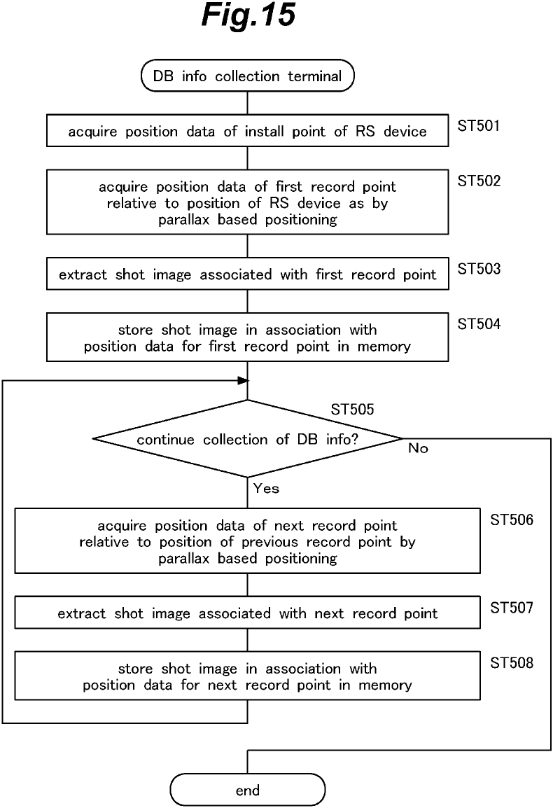

Next, an operation procedure of the DB information collection device 5 according to the second embodiment will be described. FIG. 15 is a flow chart showing the operation procedure of the DB information collection device 5.

In DB information collection terminal 5, the processor 55 first acquires position data (latitude and longitude) of the installation point of the roadside device 3 in response to a worker’s input operation to the user interface 53 (ST501).

Next, the processor 55 performs a parallax-based positioning operation to acquire the position data (latitude and longitude) of the first record point, using the position (latitude and longitude) of the installation point of the roadside device 3 as a base point (ST502). Next, the processor 55 extracts the shot image of the first record point from the shot images (frames) at times provided in sequence from the camera 51 (ST503). Then, the processor 55 stores the shot image in association with the position data of the first record point in the memory 54 (ST504).

Next, the processor 55 determines whether to continue the DB information collection operation (ST505).

When determining that the DB information collection operation is to be continued (Yes in ST505), the processor 55 performs the parallax-based positioning operation to acquire the position data (latitude and longitude) of the current record point, using the position (latitude and longitude) of the previous record point as a reference point (ST506).

Next, the processor 55 extracts the shot image of the current record point from the shot images (frames) of at times provided in sequence from the camera 51 (ST507). Then, the processor 55 stores the shot image in association with the position data of the current record point in the memory 54 (ST508).

Next, returning to ST505, the processor 55 determines whether to continue the DB information collection operation. When determining that DB information collection is to be continued (Yes in ST505), the processor 55 repeats the same operations as described above. When determining that DB information collection is not to be continued, the processor 55 ends the process (ST506).

In this way, in the present embodiment, the DB information collection terminal 5 can collect record information to be stored in the image-position DB, i.e., a shot image of a road surface at each record point and the position data of the record point. The collected shot image and position data for each record point are stored in the image-position DB of the roadside device 3.

### (Variant of Second Embodiment)

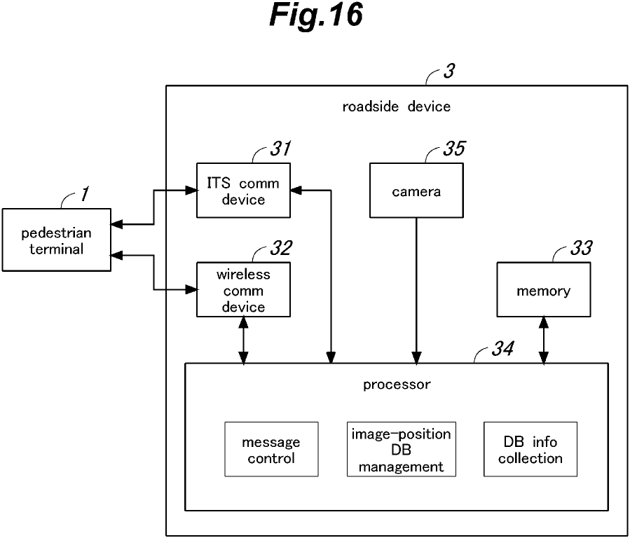

Next, a roadside device 3 according to a variant of the second embodiment will be described. Except for what will be discussed here, the variant is the same as the above-described second embodiment. FIG. 16 is a block diagram showing a schematic configuration of a roadside device 3 according to the variant of the second embodiment.

In the second embodiment, the camera 51 of the DB information collection terminal 5 captures shot images of road surfaces under the worker’s feet, and the DB information collection terminal 5 collects a shot image for each record point.

In the variant of the second embodiment, the roadside device 3 is provided with a camera 35 for collecting shot images of record points. The camera 35 is configured to capture shot images of road surfaces on which pedestrians pass (such as crosswalks, sidewalks, and roadside strips).

In the roadside device 3, the processor 34 extracts a shot image for each record point from the shot images captured by the camera 11 in the DB information collection operation. The processor 34 acquires the position data of the relative position of a record point with respect to the roadside device 3 based on the position of the record point in the shot image captured by the camera 11. Then, based on the relative position data of the record point and the position data of the installation point of the roadside device 3, the processor 34 acquires the absolute position data (latitude and longitude) of the record point. Examples of methods for acquiring relative position data involve three-point surveying using the parallax of the camera 11, and positioning based on the distance measured by the radar (not shown) provided in the roadside device 3.

### Third Embodiment

Next, operations of a pedestrian terminal 1 according to a third embodiment of the present disclosure will be described. Except for what will be discussed here, the third embodiment is the same as the above described embodiment.

In the first embodiment, the pedestrian terminal 1 performs the image-based positioning operation all the time.

In the present embodiment, the pedestrian terminal 1 performs the image-based positioning operation only when detecting a specific event that necessitates the image-based positioning operation. Specifically, in the present embodiment, the specific event that necessitates the image-based positioning operation includes a sudden increase in a pedestrian’s moving speed (sudden acceleration) or a sudden change of a pedestrian’s moving direction (sudden change of a moving direction).

A sudden acceleration of a pedestrian may be detected when the change in the pedestrian’s moving speed (acceleration), which is determined based on the detection results of the accelerometer 12, exceeds a predetermined threshold value. A sudden change of a pedestrian’s moving direction may be detected when the change in the pedestrian’s moving direction (angular velocity), which is calculated from the detection results of the gyro sensor 13, exceeds a predetermined threshold value.

In the present embodiment, the pedestrian terminal 1 performs satellite positioning and PDR positioning when detecting no specific event that necessitates the image-based positioning operation. Specifically, the pedestrian terminal 1 acquires position data of a pedestrian through periodic satellite positioning and PDR positioning until the pedestrian terminal detects a next specific event and performs the image-based positioning operation. In PDR positioning, the processor 18 estimates the current position of a pedestrian by calculating the distance and moving direction relative to the previous measured position, based on the detection results of accelerometer 12 and the gyro sensor 13.

A sudden increase in a pedestrian’s moving speed (sudden acceleration) or a sudden change of a pedestrian’s moving direction (sudden change of a moving direction) causes a decrease in the reliability of position data acquired by PDR positioning. In view of this, in the present embodiment, when detecting a sudden increase in a pedestrian’s moving speed (sudden acceleration) or a sudden change of a pedestrian’s moving direction (sudden change of a moving direction) as a specific event that necessitates the image-based positioning operation, the pedestrian terminal 1 performs the image-based positioning operation, thereby ensuring the accuracy of position data of the pedestrian.

In some cases, the pedestrian terminal 1 may perform the image-based positioning operation only for persons who are relatively prone to traffic accidents, such as the elderly or children. In other cases, the pedestrian terminal 1 may perform the image-based positioning operation only at locations where traffic accidents frequently occur. Furthermore, the pedestrian terminal 1 may perform the image-based positioning operation when the elderly or children are located outside of the routes they usually or frequently pass through. The pedestrian terminal 1 carried by an elderly person or a child may notify their guardian’s pedestrian terminal 1 of a result of the image-based positioning operation (image-based positioning information), and/or the pedestrian terminal 1 may provide an alert to the elderly or the child as necessary based on a result of the image-based positioning operation. This configuration can enhance the function of watching over the elderly or children.

Moreover, the pedestrian terminal 1 may perform the image-based positioning operation when determining that the distance between the elderly or the child and their guardian has exceeded a predetermined distance. When necessary, a guardian may use the guardian’s pedestrian terminal 1 to provide a positioning instruction to cause the pedestrian terminal 1 carried by an elderly person or child to perform the image-based positioning operation. This feature can help preventing a child or an elderly person from getting lost or wandering around.

Alternatively, the system with pedestrian terminals 1 may be configured such that facial data of an elderly person or child can be recorded in guardian’s pedestrian terminal 1 beforehand, and that, when the guardian’s pedestrian terminal 1 no longer recognizes the face of the elderly person or child, the guardian’s pedestrian terminal 1 provides a positioning instruction to cause the pedestrian terminal 1 carried by the elderly person or child to perform the image-based positioning operation.

A longer time of use of PDR positioning causes the accumulation of positioning errors, causing a decrease in the reliability of position data acquired by PDR positioning. In view of this, when the distance of a continuous PDR positioning section (a section where PDR positioning is continuously performed) exceeds a predetermined threshold value, the pedestrian terminal 1 may detect it as a specific event that necessitates the image-based positioning operation, and performs the image-based positioning operation.

In this way, in the present embodiment, the image-based positioning operation is performed upon detection of a specific event that necessitates the image-based positioning operation. This feature reduces the frequency of execution of the image-based positioning operation, thereby enabling reduced processing load on a processor 18 for the image matching operation.

In the present embodiment, when a pedestrian enters a nearby area of an intersection, the pedestrian terminal 1 acquires record information from the image-position DB in the roadside device 3 and performs the image-based positioning operation. However, there are some places where satellite positioning becomes inaccurate due to the shielding of satellite signals (such as in tunnels), or due to the multipath of radio waves or reflected waves (such as in high-rises). When in such a place, although the pedestrian terminal 1 is still able to acquire position data of the pedestrian by using PDR positioning, a longer time of use of PDR positioning causes a decrease in the reliability of position data.

In view of this, the pedestrian terminal 1 may be configured to acquire position data of a pedestrian by using satellite positioning under normal conditions, and to change the positioning method from satellite positioning to PDR positioning when detecting satellite positioning does not properly work (such as when in a tunnel or in high-rises). Moreover, the pedestrian terminal 1 may be configured to change the positioning method from satellite positioning to PDR positioning when a time of use of PDR positioning becomes longer. In some cases, the pedestrian terminal 1 may be configured to change the positioning method from satellite positioning directly to image-based positioning.

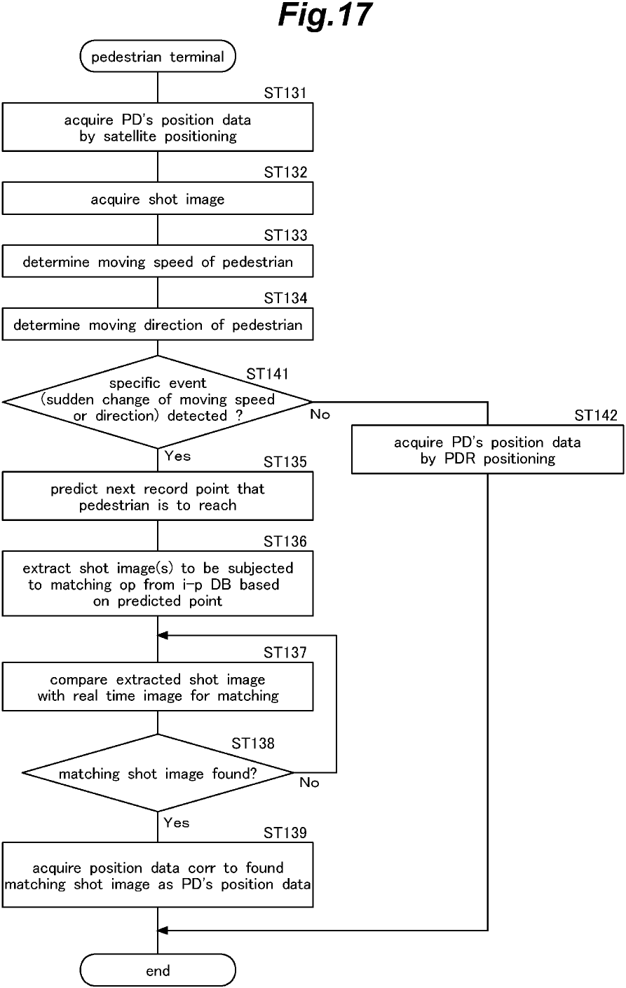

Next, an operation procedure of the pedestrian terminal 1 according to the third embodiment of the present disclosure will be described. FIG. 17 is a flow chart showing an operation procedure of the pedestrian terminal 1. The operation procedure of the roadside device 3 is the same as that of the first embodiment (see FIG. 1).

The pedestrian terminal 1 performs the same operations as in the first embodiment (see FIGS. 7(A), 7(B), and 7(C)).

As shown in FIG. 17, in the pedestrian terminal 1, the processor 18 performs processing steps from acquiring the position data of the pedestrian’s position by using the satellite positioning device 14, to determining the pedestrian’s moving direction based on the detection results of the gyro sensor 13, in the same manner as the first embodiment (ST131 to ST134 in FIG. 8).

Next, in the present embodiment, the processor 18 determines whether or not a specific event that necessitates the image-based positioning operation is detected (ST141). In this case, the specific event includes a sudden increase in a pedestrian’s moving speed (sudden acceleration) or a sudden change of a pedestrian’s moving direction (sudden change of a moving direction). The processor detects a specific event based on the pedestrian’s moving speed determined from the detection results of the accelerometer 12 or the moving direction determined from the detection results of the gyro sensor 13.

When the processor detects a specific event that necessitates image-based positioning (Yes in ST141), the process proceeds to the record point prediction operation (ST135). The processing steps after the record point prediction operation (ST135 to ST139) are the same as those of the first embodiment (see FIG. 8).

When detecting no specific event that necessitates image-based positioning (No in ST141), the processor 18 acquires position data of the pedestrian by using PDR positioning (ST142).

### Fourth Embodiment

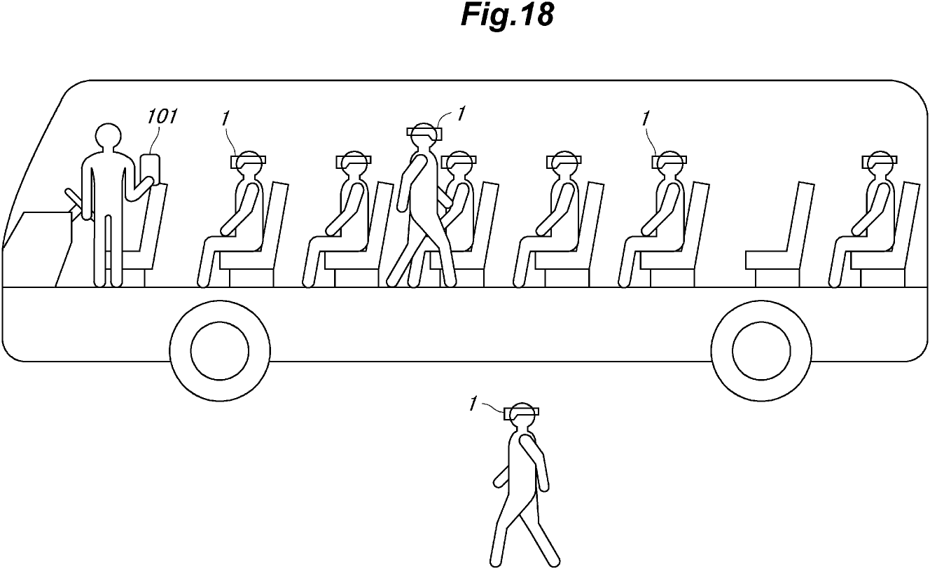

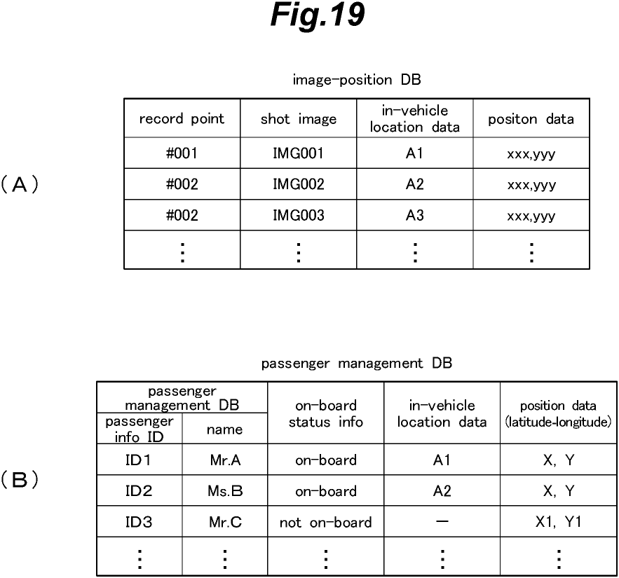

Next, a passenger management system according to a fourth embodiment of the present disclosure will be described. Except for what will be discussed here, the fourth embodiment is the same as the above described embodiments. FIG. 18 is a diagram showing an overall configuration of the passenger management system according to the fourth embodiment. FIG. 19 is an explanatory diagram showing examples of stored data in an image-position DB and a passenger management DB.

When a bus is used for group travel, on-board confirmation i.e., confirming that all passengers are on-board the bus is required to prior to departure from the departure place or a stop along the way. The on-board confirmation is not so troublesome for a person who manages the travel and remembers the faces and names of the passengers to perform, but is quite troublesome for a bus crew (driver or guide) tries to perform. Thus, there is a need for what enables a bus crew to perform on-board confirmation efficiently.

In view of this, a system of the present embodiment is configured such that record points are preset at each seat and in the aisle in a bus so that the system can identify where each passenger is present in the vehicle, and an image-position DB contains, for each record point, a shot image in association with position data, and in-vehicle location data (in-vehicle location information) indicating where the record point is located in the vehicle (see FIG. 19(A)).

When a matching shot image to a real time image is found in the image matching operation, the pedestrian terminal 1 carried by a passenger acquires the position data (latitude and longitude) of a record point associated with the matching shot image contained in the image-position DB, as the position data of the pedestrian’s current position. The pedestrian terminal 1 determines whether or not a passenger is on-board based on the in-vehicle location data corresponding to the record point associated with the matching shot image, and when determining that the passenger is on-board, the pedestrian terminal 1 identifies which seat the passenger is seated on.

In the present embodiment, as in the first embodiment, the camera 11 of the pedestrian terminal 1 captures shot images of surfaces under the feet of the passenger (pedestrian). When the passenger is seated on a seat, a shot image shows the seat surface and armrest(s) of the seat on which the passenger is seated and the floor surface between the seat and the seat in front. When the passenger is in the aisle, a shot image shows the floor under the passenger’s feet and a part of the seat(s). As the positional relationship of objects in a shot image, as well as patterns and deteriorated points (e.g., cracks) of the objects can be unique characteristics of an in-vehicle location, the pedestrian terminal 1 can identify the current in-vehicle location of the passenger based on these characteristics, in the image matching operation.

In the present embodiment, a crew member carries a crew terminal 101 (base station device). The pedestrian terminal 1 transmits to the crew terminal 101 notification information including on-board status information indicating whether or not each passenger is on-board and in-vehicle location data indicating where each passenger is located in the vehicle. Upon receiving the notification information from the pedestrian terminal 1, the crew terminal 101 displays the information with no processing operation thereon, or with execution of statistical processing operations thereon as necessary.

As shown in FIG. 19(B), the crew terminal 101 manages passengers using a passenger management DB. The passenger management DB contains passenger information (passenger ID, passenger name), on-board status information, in-vehicle location data, and position data (latitude and longitude).

A passenger ID is the terminal ID of a pedestrian terminal 1 carried by a passenger. On-board status information indicates whether or not a passenger is on-board or not. In-vehicle location data indicates where a passenger is located in the vehicle. When the passenger is seated on a seat, in-vehicle location data is seat information (seat number) that identifies the passenger’s seat. When the passenger is in an aisle, the in-vehicle location data is aisle information that identifies the aisle in which the passenger is located. Position data (latitude and longitude) is the position data of the pedestrian terminal 1. When a passenger is on-board, the position data is included in a wireless communication message received from the pedestrian terminal 1, and when a pedestrian is not on-board, the position data is included in an ITS communication message received from the pedestrian terminal 1.

In this way, a system of the present embodiment enables a pedestrian terminal 1 to recognize whether or not the passenger carrying the pedestrian terminal 1 is on-board. Moreover, the pedestrian terminal 1 can provide on-board status information indicating whether or not the passenger is on-board to a crew terminal 101, which enables a crew member carrying the crew terminal 101 to easily do on-board confirmation; that is, confirm that all passengers are on-board.

Although the above-described system of the present embodiment is used in on-board confirmation of passengers on buses, the configuration of this embodiment can be applied to on-board confirmation of passengers on other vehicles, such as trains, aircraft, and ships. Furthermore, the configuration of the present embodiment can also be used for admission confirmation, confirming whether or not an admitted user has entered a facility such as an event venue or a concert hall.

In other cases, the system of the present embodiment may be configured to perform the image-based positioning operation only when the system determines that a bus passenger is outside a specific location at a specific time. For example, the specific time may be a time in the time period from a predetermined time before the bus departure to the bus departure time, and the specific location may be a location that is more than a predetermined distance away from the bus.

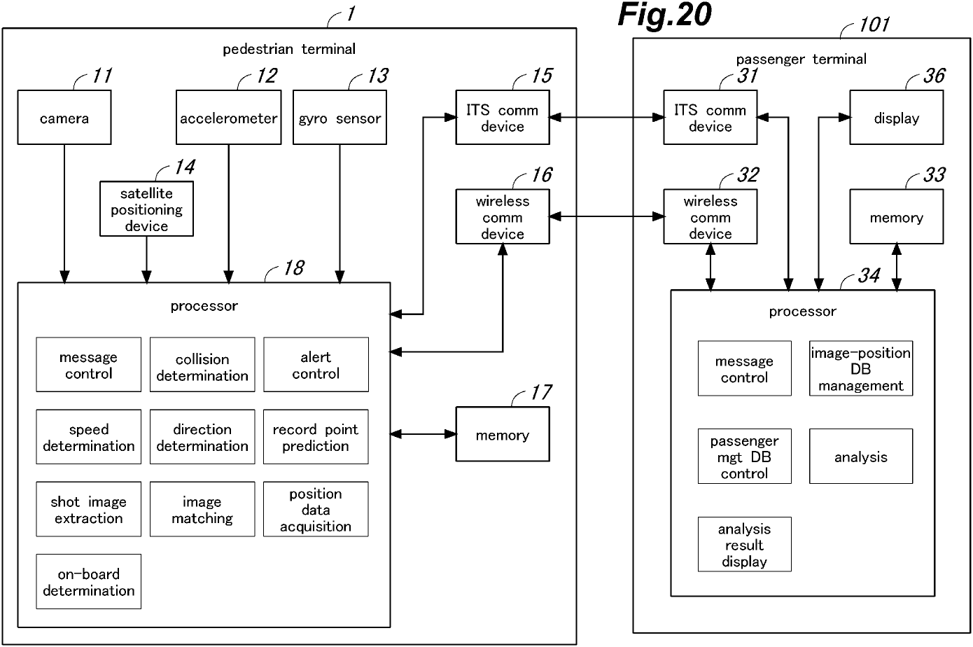

Next, a pedestrian terminal 1 and a crew terminal 101 according to the fourth embodiment will be fourth embodiment. FIG. 20 is a block diagram showing schematic configurations of the pedestrian terminal 1 and the crew terminal 101.

The pedestrian terminal 1 includes a camera 11, an accelerometer 12, a gyro sensor 13, a satellite positioning device 14, an ITS communication device 15, a wireless communication device 16, a memory 17, and a processor 18, as in the first embodiment (see FIG. 6).

The processor 18 of the pedestrian terminal 1 performs the same operations as the first embodiment (see FIG. 6), including a message control operation, a collision determination operation, an alert control operation, a speed determination operation, a direction determination operation, a record point prediction operation, a shot image extraction operation, an image matching operation, and position data acquisition operation. In the present embodiment, the processor 18 further performs a on-board determination operation.

In the on-board determination operation, the processor 18 determines whether or not a passenger is on-board based on in-vehicle location data (seat number, or aisle information) corresponding to the record point associated with a matching shot image found in the image matching operation. Specifically, when there is in-vehicle location data corresponding to the record point associated with a found matching shot image, the processor 18 determines that a passenger is on-board. When there is not in-vehicle location data corresponding to the record point associated with a found matching shot image, the processor 18 determines that a passenger is not on-board. The on-board determination operation generates on-board status information that indicates whether or not a passenger is on-board.

The crew terminal 101 (base station device) includes an ITS communication device 31, a wireless communication device 32, a memory 33, and a processor 34, in a similar manner to the roadside device 3 of the first embodiment (see FIG. 6). In the present embodiment, the crew terminal 101 is equipped with a display 36.

The memory 33 stores record information in the image-position DB (see FIG. 19(A)). In the present embodiment, the image-position DB contains, for each record point, corresponding position data and in-vehicle location data, in association with a shot image of the record point.

The memory 33 stores record information in the passenger management DB (see FIG. 19(B)). The passenger management DB contains, for each passenger, passenger information (passenger ID, passenger name), on-board status information indicating whether the passenger is on-board and in-vehicle location (such as seat, aisle) where the passenger is present, and position data (latitude and longitude).

The display 36 displays analysis result information generated by the processor 34.

The processor 34 performs a message control operation and an image-position DB management operation as in the roadside device 3 of the first embodiment (see FIG. 6). In the present embodiment, the processor 34 further performs a passenger management DB control operation, an analysis operation, and an analysis result display operation.

In the passenger management DB control operation, the processor 34 manages the passenger management DB (see FIG. 19(B)).

In the analysis operation, the processor 34 performs statistical processing operations using record information in the passenger management DB. Specifically, the processor 34 generates a list of passenger’s on-board statuses as analysis result information, which enables a user (crew) to confirm the passenger’s on-board statuses at a glance.

In the analysis result display operation, the processor 34 controls the display 36 such that the display shows analysis result information. This enables the driver, guide, or other crew members to check passenger on-board statuses.

In the present embodiment, the crew terminal 101 functions as a base station device that is similar to the roadside device 3 in the first embodiment, and manages the passenger management DB to enable delivery of record information in the passenger management DB to the pedestrian terminal 1. However, in other cases, an in-vehicle terminal mounted on a bus may function as a base station device.

In the present embodiment, the crew terminal 101 performs the analysis operation using record information in the passenger management DB. However, the record information in the passenger management DB may be uploaded from the crew terminal 101 onto a management server, where the analysis operation can be performed.

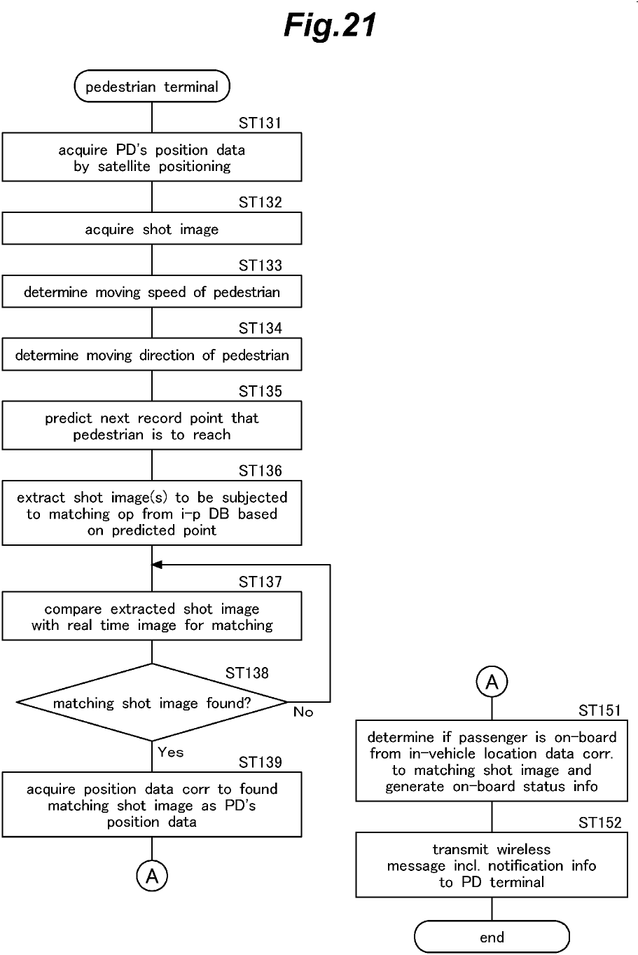

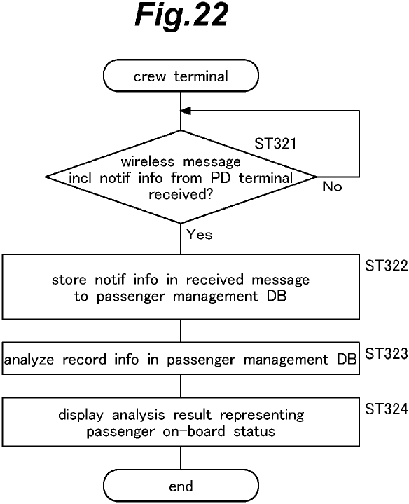

Next, operation procedures of a pedestrian terminal 1 and a crew terminal 101 according to the fourth embodiment will be described. FIG. 21 is a flow chart showing an operation procedure of the pedestrian terminal 1, and FIG. 22 is a flow chart showing an operation procedure of the crew terminal 101.

The pedestrian terminal 1 performs the same operations as in the first form (see FIGS. 7(A), 7(B), and 7(C)).

The crew terminal 101 performs the same operations as the roadside device 3 of the first embodiment (see FIGS. 10(A) and 10(B)).

As shown in FIG. 21, as in the first embodiment (see FIG. 8), the processor 18 in the pedestrian terminal 1 performs processing steps from acquiring the position data of the pedestrian’s position by using the satellite positioning device 14 to acquiring the position data of the record point associated with a matching shot image as the position data of the pedestrian’s current position (ST131 to ST139).

Next, in the present embodiment, the processor 18 performs the on-board determination operation, i.e., determining whether or not a passenger is on-board and generates on-board status information indicating whether or not the passenger is on-board based on in-vehicle location data (seat number, aisle information) corresponding to the record point associated with a matching shot image found in the image matching operation (ST151).

Next, in response to a transmission instruction from the processor 18, the wireless communication device 16 transmits a wireless communication message containing notification information to the crew terminal 101 via wireless communications (ST152). The notification information includes, for each passenger, passenger information (passenger ID, passenger name), on-board status information indicating whether or not the passenger is on-board, in-vehicle location data (seat number, aisle information) corresponding to the location where the passenger is present (such as seat, or aisle), and position data (latitude and longitude).

As shown in FIG. 22, in the crew terminal 101, when the wireless communication device 32 receives a wireless communication message containing notification information from the pedestrian terminal 1 (Yes at ST321), the processor 34 stores the received notification information in the passenger management DB, where the notification information includes, for each passenger, passenger information (passenger ID, passenger name), on-board status information, in-vehicle location data, and position data (latitude and longitude) (ST322).

Next, processor 34 performs the analysis operation (including statistical processing operations) as necessary on the record information in the passenger management DB to generate analysis result information to be provided to staff such as a crew member (ST323).

Next, the processor 34 controls the display 36 so that the display shows analysis result information representing an on-board status of each passenger (ST324), which allows the driver, guide, or other crew member to check the on-board status of a passenger.

### Fifth Embodiment

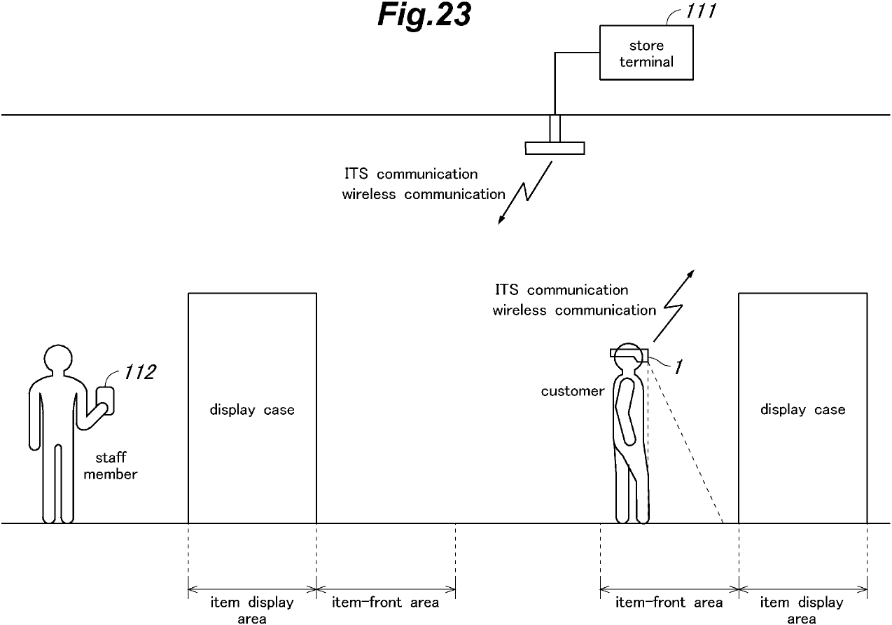

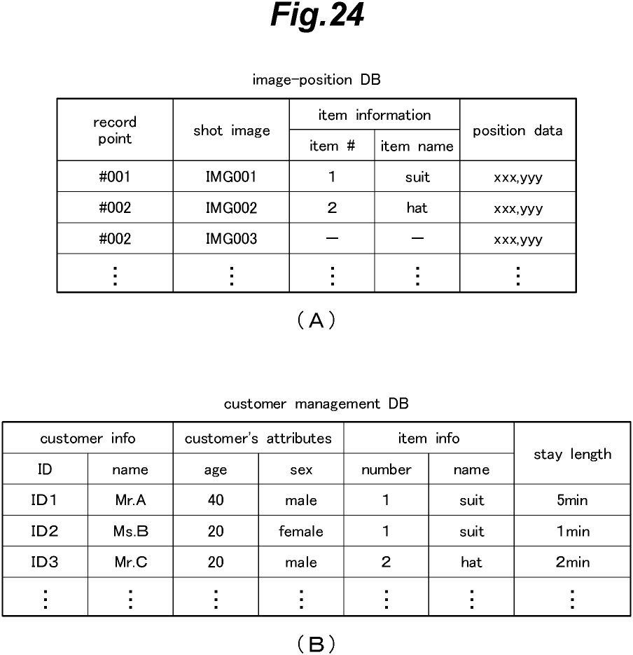

Next, a customer management system according to a fifth embodiment of the present disclosure will be described. Except for what will be discussed here, the fifth embodiment is the same as in the above described embodiments. FIG. 23 is a diagram showing an overall configuration of the customer management system according to the fifth embodiment. FIG. 24 is an explanatory diagram showing examples of stored data in an image-position DB and a customer management DB.

In a commercial facility such as a shopping mall, measuring a time that a customer stays in front of a display case or other showcase displaying a merchandise item provides a stay length, i.e., the length of time that the customer spent there, which represents the customer’s level of interest in the merchandise item. Furthermore, counting customers staying in front of a display case or other store window provides the number of customers indicates the number of customers who showed interest in a merchandise item.

Therefore, such information on customers’ stay statuses (customer’s stay length, number of stayed customers) can be used for marketing and other facility management tasks. In addition, when a system can identify a customer by each terminal ID of a pedestrian terminal 1 carried by the customer, the system can provide a customer with individualized information on items of interest to the customer based on information about the customers’ stay status.

Therefore, in the present embodiment, item display areas where display cases or other showcases displaying merchandise items are placed are determined beforehand, and item-front areas adjacent to the respective item display areas where customers can stay to look at the displayed merchandise items are also preliminarily determined. For each record point located in an item-front area, the image-position DB contains, in addition to position data of the record point, item information (item ID information) about a merchandise item corresponding to the item-front area (see FIG. 24(A)).

The pedestrian terminal 1 carried by a customer can acquire, as the position data of the customer’s current position, position data of a record point associated with a matching shot image to a real time image found in the image matching operation on the image-position DB. Furthermore, the pedestrian terminal 1 determines, based on item information corresponding to the record point associated with the matching shot image, whether or not the customer is in an item-front area and which item-front area the customer is present.

In the resent embodiment, the pedestrian terminal 1 acquires a stay length, i.e., the length of the time a customer spent in an item-front area, as information on the customer’s stay status in the item-front area. In other cases, the pedestrian terminal 1 may be configured to acquire the number of customers staying in an item-front area as information on customers’ stay statuses in the item-front area.

In the present embodiment, as in the first embodiment, the camera 11 of the pedestrian terminal 1 captures shot images of surfaces under the feet of a customer (pedestrian). A shot image captured by the camera 11 shows a floor surface under the feet of the customer. As patterns and deteriorated points (e.g., cracks) seen in the floor material can be unique characteristics associated with a shot image, the pedestrian terminal 1 can identify, based on these characteristics, the current position of the customer in the image matching operation. Moreover, a shot image may show, in addition to a floor surface, side surfaces of objects on a surface in an item display area (such as display shelf, display case, and display stand) and walls of a building. Patterns and deteriorated points of these objects can be also unique characteristics of the shot location.

In the present embodiment, a store terminal 111 (base station device) is installed in a store. The store terminal 111 has the same configuration as the roadside device 3 in the first embodiment (see FIG. 6). The store terminal 111 contains an image-position DB, and delivers record information in the image-position DB to pedestrian terminals 1 within a store. In other cases, a management server located within a store or other place may contain the image-position DB and deliver record information in the image-position DB to pedestrian terminals 1 via the store terminal 111.

In the present embodiment, as shown in FIG. 24(B), the store terminal 111 manages customer information using a customer management DB. This customer management DB contains, for each customer, customer ID information, customer attribute information (age, gender), item information (item number, item name), and stay length information.

Customer ID information is the terminal ID of a pedestrian terminal 1 carried by a customer, and can be acquired from the pedestrian terminal 1. Customer attribute information is information about the attributes of a customer (pedestrian) and can be acquired from the pedestrian terminal 1. The item information is information that identifies a merchandise item for an item-front area where a customer stayed, i.e., the merchandise item in which the customer showed interest. Stay length inflation is a time a customer spent in the item-front area.

In this way, a system of the present embodiment can acquire information on a stay status (such as stay length) of each customer in an item-front area. The information on a customer’s stay status can be used for store marketing and other purposes.

In the present embodiment, in a commercial facility such as a shopping mall, the system acquires customers’ stay statuses (such as stay length, number of stayed customers) in each item-front area, so that the acquired information on the stay status of each customer can be used for facility management tasks. In other cases, in an entertainment facility such as a theme park, a system may be used to acquire visitors’ stay statuses (such as stay length, number of stayed visitors) for each area such as an attraction area or show stage area, so that the acquired information on the stay statuses of visitors can be used for facility management tasks.

In the present embodiment, analysis operation is performed using record information in the customer management DB. For an entertainment facility such as a theme park, similar analysis can be done on record information, to e.g., determine areas of high interest to visitors (e.g., attraction areas).

In some cases, a pedestrian terminal 1 can display on its display screen item information corresponding to a record point associated with a matching shot image, to thereby provide a promotion service for facilitating a customer’s understanding of an item. In this case, the pedestrian terminal 1 may retrieve detailed information about the item from the store terminal 111 and display the acquired information on the screen.

The customer management system of the present embodiment can also be modified into a user monitoring system. For example, the system may be used to find a lost child in a commercial facility such as a shopping mall or entertainment facility such as a theme park. Specifically, the system enables a user to input the identity of a family member in a pedestrian terminal 1 beforehand, and when the distance between a parent and a child becomes greater than a predetermined value after entering a facility, the system may perform the image-based positioning operation on the child’s pedestrian terminal 1, allowing the parent to recognize the details of the child’s current position. In this case, the system may be configured such that the frequency of the image-based positioning operation is changed depending on to the distance between the parent and the child.

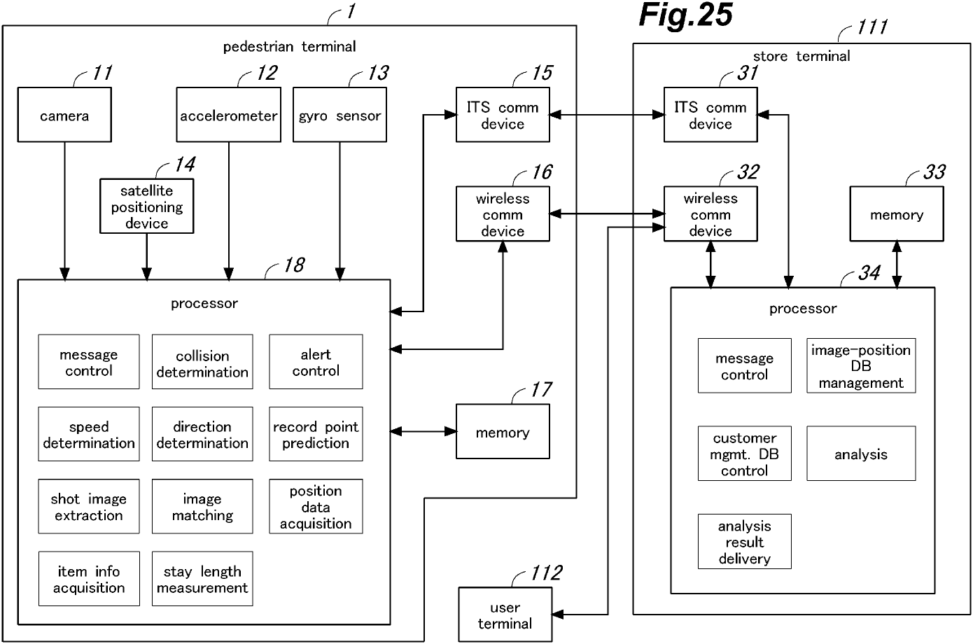

Next, a schematic configuration of a pedestrian terminal 1 and a store terminal 111 of the fifth embodiment will be described. FIG. 25 shows a block diagram of the schematic configuration of the pedestrian terminal 1 and the store terminal 111.

The pedestrian terminal 1 includes a camera 11, an accelerometer 12, a gyro sensor 13, a satellite positioning device 14, an ITS communication device 15, a wireless communication device 16, a memory 17, and a processor 18, as in the first embodiment (see FIG. 6).

The memory 17 stores, in addition to programs that are executable by the processor 18, the terminal ID of the pedestrian terminal 1 and the attribute information (age, gender, etc.) of a customer who carries the pedestrian terminal 1.

The processor 18 performs the same operations as the first embodiment (see FIG. 6), including a message control operation, a collision determination operation, an alert control operation, a speed determination operation, a direction determination operation, a record point prediction operation, a shot image extraction operation, an image matching operation, and position data acquisition operation. In the present embodiment, the processor 18 further performs an item information acquisition operation and a stay length measurement operation.

In the item information acquisition operation, the processor 18 determines whether or not a customer is in an item-front area based on item information (such as item number, item name) corresponding to a record point associated with a matching shot image found in the image matching operation. When determining that the customer is in the item-front area, the processor 18 acquires item information corresponding to the record point associated with the matching shot image, as item information on an item for the item-front area where the customer has stayed.

In the stay length measurement operation, based on the time when a matching shot image, which corresponds to item information, is found, the processor 18 acquires the entry time when a customer entered an item-front area, and the exit time when the customer exited the item-front area. Then, based on the entry time and the exit time, the processor 18 measures the customer’s stay length, i.e., the length of time the customer spent in the item-front area.

In the present embodiment, the pedestrian terminal 1 determines in which item-front area a customer is present based on item information corresponding to a record point associated with a matching shot image found in the image matching operation. In other cases, the pedestrian terminal 1 may determine in which item-front area a customer is located, based on position data of the customer’s current position acquired in the position data acquisition operation and area map information indicating the boundary defining an item-front area.

The store terminal 111 (base station device) includes an ITS communication device 31, a wireless communication device 32, a memory 33, and a processor 34, as in the roadside device 3 of the first embodiment (see FIG. 6).

The memory 33 stores record information in the image-position DB (see FIG. 24(A)). In the present embodiment, the image-position DB contains, for each record point, position data of a record point and corresponding item information, in association with a shot image of the record point. When the record point is located in an item-front area, item information on an item which corresponds to the item-front area is recorded in the image-position DB.

The memory 33 stores record information in the customer management DB (see FIG. 24(B)). The customer management DB contains, for each customer, customer ID information, customer attribute information (age, gender), item information (item number, item name) on an item corresponding to an item-front area where the customer stayed, and a stay length of time the customer stayed in the item-front area.

The processor 34 performs a message control operation and an image-position DB management operation in a similar manner to the roadside device 3 of the first embodiment (see FIG. 6). In the present embodiment, the processor 34 further performs a customer management DB control operation, an analysis operation, and an analysis result delivery operation.

In the customer management DB control operation, the processor 34 manages the customer management DB (see FIG. 24(B)).

In the analysis operation, the processor 34 performs statistical processing operations and other operations, using record information stored in the customer management DB.

In the analysis result delivery operation, the processor 34 controls the wireless communication device 32 so that the wireless communication device 32 delivers analysis result information acquired in the analysis operation to user terminals 112 carried by staff members such as a store manager and store employees. Communication methods used to deliver information to the user terminals 112 are not limited to wireless communications.

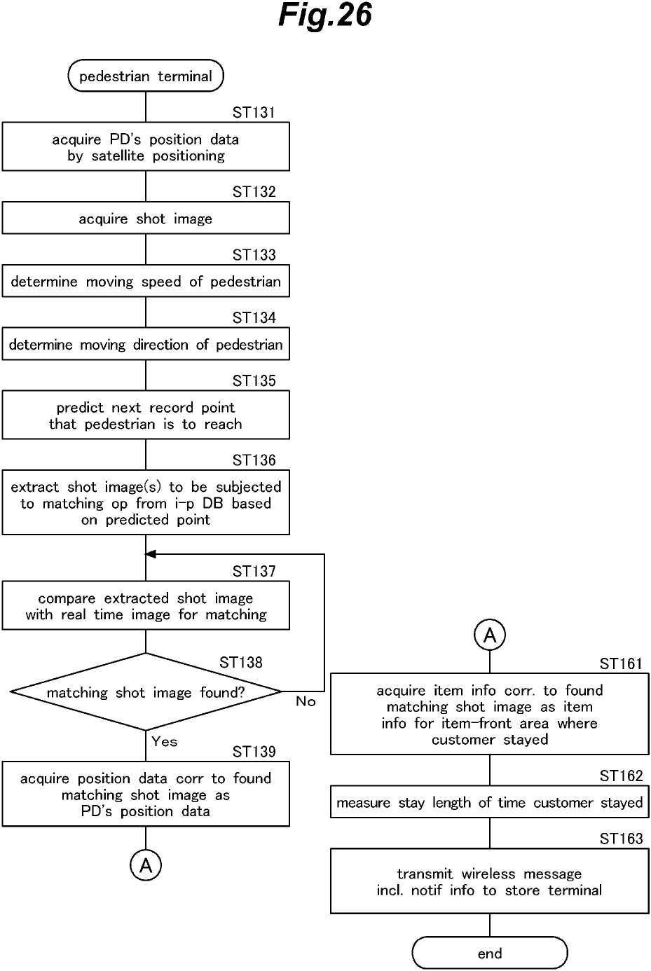

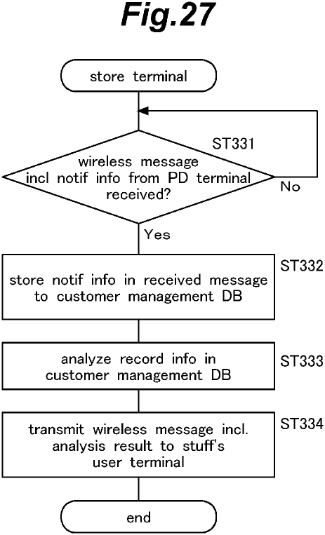

Next, operation procedures of a pedestrian terminal 1 and a store terminal 111 of the fifth embodiment will be described. FIG. 26 is a flow chart showing an operation procedure of the pedestrian terminal 1. FIG. 27 is a flow chart showing an operation procedure of the store terminal 111.

The pedestrian terminal 1 performs the same operations as in the first embodiment (see FIGS. 7(A), 7(B), and 7(C)).

The store terminal 111 performs the same operations as the roadside device 3 of the first embodiment (see FIGS. 10(A) and 10(B)).

As shown in FIG. 26, in the pedestrian terminal 1, the processor 18 performs processing steps, from acquiring the position data of the pedestrian’s position by using the satellite positioning device 14 to acquiring the position data of the record point associated with a matching shot image as the position data of the pedestrian’s current position data in the same manner as the first embodiment (ST131 to ST139 in FIG. 8).

Next, in the present embodiment, the processor 18 performs the item information acquisition operation, i.e., determining whether or not a customer is in an item-front area based on item information (item number, item name) corresponding to the record point associated with a matching shot image found in the image matching operation. When determining that the customer is in the item-front area, the processor 18 acquires item information corresponding to the record point associated with a matching shot image, as item information on an item for the item-front area where the customer has stayed (ST161).

Moreover, the processor 18 performs the stay length measurement operation; that is, acquires, based on the time of finding the matching shot image corresponding to the item information, the entry time when the customer entered the item-front area and the exit time when the customer exited the item-front area, and then based on the entry time and the exit time, the processor 18 measures the customer’s stay length, i.e., the length of the time when the customer stayed in an item-front area (ST162).

Next, in response to a transmission instruction from the processor 18, the wireless communication device 16 transmits a wireless communication message containing notification information to the store terminal 111, the notification information including the terminal ID of the pedestrian terminal 1, customer attribute information on the customer carrying the pedestrian terminal 1, item information (item number, item name) on the merchandise item for the item-front area where the customer stayed, and the stay length.

As shown in FIG. 27, in the store terminal 111, when the wireless communication device 32 receives a wireless communication message containing notification information from the pedestrian terminal 1 (Yes at ST331), the processor 34 stores the received notification information in the customer management DB (see FIG. 24(B)), the notification information including, for each customer, the terminal ID of a pedestrian terminal 1, customer attribute information on the customer carrying the pedestrian terminal 1, item information (item number, item name) on a merchandise item for the item-front area where the customer stayed, and the stay length (ST332).

Next, the processor 34 performs the analysis operation (including statistical processing operations) as necessary on the record information in the customer management DB to generate analysis result information (such as a list of results) to be provided to staff members such as store employees (ST333).

Next, in response to a transmission instruction from the processor 34, the wireless communication device 32 transmits a wireless communication message containing notification information to user terminals 112 carried by staff members (ST334). The analysis result information is then displayed on the staff’s user terminals 112.

In the present embodiment, the pedestrian terminal 1 performs the stay length measurement operation. However, in other embodiments, the store terminal 111 may perform the stay length measurement operation. In this case, the pedestrian terminal 1 transmits to the store terminal 111 a time when a matching shot image is found at a corresponding record point in the image matching operation (a time when a matching shot image to a real time image is found).

In the present embodiment, a store terminal 111 performs the analysis operation using record information in the customer management DB. However, in other cases, the record information in the customer management DB may be uploaded from a store terminal 111 onto a management server, where the analysis operation can be performed.

### Sixth Embodiment

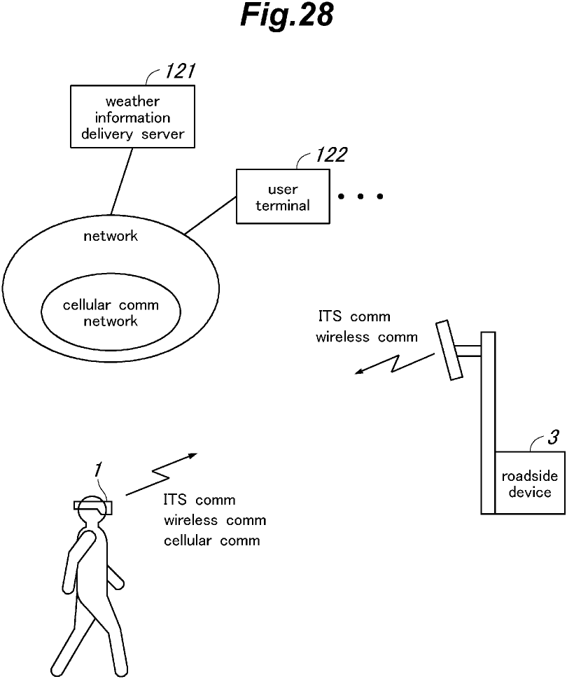

Next, a system according to a sixth embodiment of the present disclosure will be described. Except for what will be discussed here, the sixth embodiment is the same as in the above described embodiments. FIG. 28 is a diagram showing an overall configuration of a weather information delivery system according to the sixth embodiment.

The condition of a road surface under a pedestrian’s feet varies with changes in weather. For example, in sunny wither, the road surface is dry; in rainy weather, the road surface becomes wet; in snowy weather, the road surface becomes snow-covered; and in heavy rainfall, the road surface can be flooded. Thus, a pedestrian terminal 1 can estimate the weather at a pedestrian’s current position based on the shot image of a road surface under the pedestrian’s feet.

In the present embodiment, shot images of road surfaces under the pedestrian’s feet at record points are collected by different weathers (such as sunny, rainy, or snowy), and stored in the roadside device 3 such that the image-position DB therein contains, for each record point, position data of the record point in association with a shot image and further with weather information on the weather at the record point when the shot image was captured. Data stored in the image-position DB is the same as that of the first variant of the first embodiment (See FIG. 11(A)).

When finding a matching shot image to a real time image in the image matching operation, the pedestrian terminal 1 acquires position data of the record point associated with the matching shot image as position data of the pedestrian’s current position. In addition, the pedestrian terminal 1 acquires weather information corresponding to the record point where the matching shot image is found as weather information for the pedestrian’s current position. Then, the pedestrian terminal 1 uploads the position data of the pedestrian’s current position along with the weather information onto a weather information delivery server 121 (weather information collection device).

The weather information delivery server 121 is configured as a cloud computer. The weather information delivery server 121 can communicate with a pedestrian terminal 1 via a cellular communication network, and collects position data of the pedestrian’s current position along with corresponding weather information from the pedestrian terminal 1. The weather information delivery server 121 performs statistical processing operations on the position data and weather information of the pedestrian’s current position collected from the pedestrian terminal 1 to generate local weather information. The weather information delivery server 121 can communicate with a user terminal 122 via the Internet and deliver the local weather information to the user terminal 122.

The local weather information is information about weather in each region. Through statistical processing operations, the weather information delivery server 121 acquires weather information for each measurement point from the position data and associated weather information for the current position of each pedestrian, using the pedestrian’s current position as the measurement point. The weather information delivery server 121 maps the acquired weather information for each measurement point on a map to generate local weather information. For example, a measurement target area is divided into mesh-like sections, and the server 121 performs statistical processing operations to allocate pieces of weather information on measurement points to the respective sections, thereby generating weather information for each section as local weather information.

In this way, in the present embodiment, as the weather information delivery server 121 is configured to collect position data of a pedestrian’s current position along with corresponding weather information from the pedestrian terminal 1, the server can generate detailed local weather information. For example, with regard to the size of each section for which local weather information is generated, when the image-position DB contains data records collected at record points positioned at intervals of 25 cm, a section may have both horizontal and vertical sizes of equal to or less than 1 m.

In some cases, shot images of road surfaces at all the record points are collected in different weather conditions and stored in the image-position DB. However, given the fact that weather information does not require such high accuracy as position data, only shot images of road surfaces at a reduced number of record points may be collected in different weathers and stored in image-position DB.

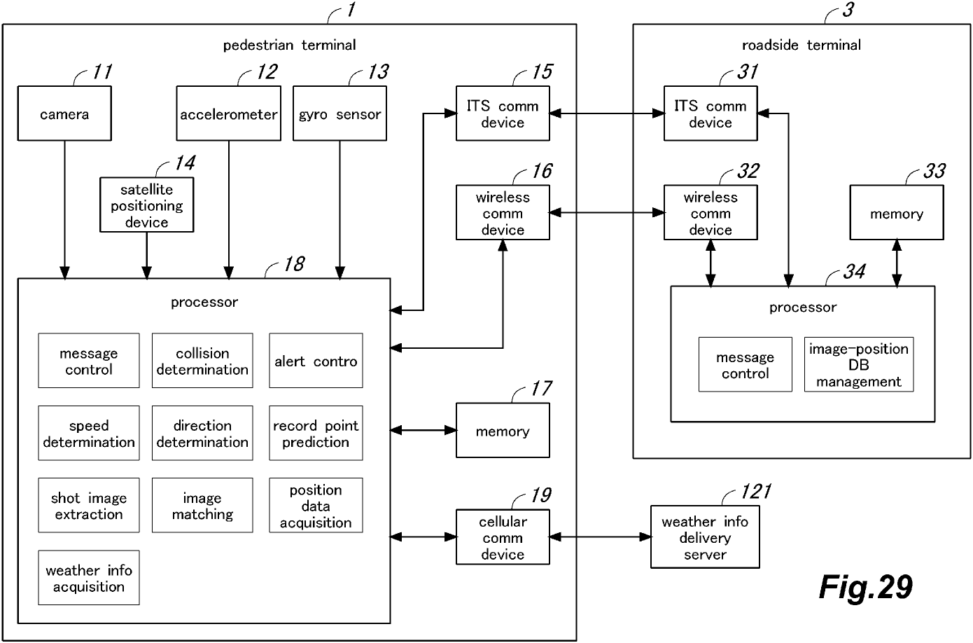

Next, schematic configurations of a pedestrian terminal 1 and a roadside device 3 of the sixth embodiment will be described. FIG. 29 is a block diagram showing schematic configurations of the pedestrian terminal 1 and the roadside device 3.

The pedestrian terminal 1 includes a camera 11, an accelerometer 12, a gyro sensor 13, a satellite positioning device 14, an ITS communication device 15, a wireless communication device 16, a memory 17, and a processor 18, as in the first embodiment (see FIG. 6). In addition, in the present embodiment, the pedestrian terminal 1 includes a cellular communication device 19.

The cellular communication device 19 communicates with the weather information delivery server 121 via a cellular communication network.

The processor 18 of the pedestrian terminal 1 performs the same operations as the first embodiment (see FIG. 6), including a message control operation, a collision determination operation, an alert control operation, a speed determination operation, a direction determination operation, a record point prediction operation, a shot image extraction operation, an image matching operation, and position data acquisition operation. In the present embodiment, the processor 18 further performs a weather information acquisition operation.

In the image matching operation, the processor 18 compares each of the shot images of a record point captured in different weather conditions (such as sunny, rainy, and snowy) and stored in the image-position DB, with a real time image provided from camera 11 for matching.

In the weather information acquisition operation, the processor 18 acquires weather information corresponding to the record point associated with a matching shot image found in the image matching operation, as the weather information for the pedestrian’s current position. The cellular communication device 19 transmits the acquired weather information to the weather information delivery server 121.

The roadside device 3 includes an ITS communication device 31, a wireless communication device 32, a memory 33, and a processor 34, as in the first embodiment (see FIG. 6).

The memory 33 of the roadside device 3 stores record information in the image-position DB. In the present embodiment, shot images of road surfaces at the respective record points are collected in different weather conditions (such as sunny, rainy, and snowy conditions), and stored such that the image-position DB in the roadside device 3 contains position data of each record point in association with a shot image and with weather information on a weather when the shot image of captured.

In the present embodiment, the roadside device 3 may communicate with a pedestrian terminal 1 only through cellular communications, and all the functions of the roadside device 3 may be stored in the cloud, to thereby provide image-position DB management for a wider area. This configuration allows a pedestrian terminal 1 to acquire weather information in any of locations within a wider area, not limited to a nearby area around the roadside device 3.

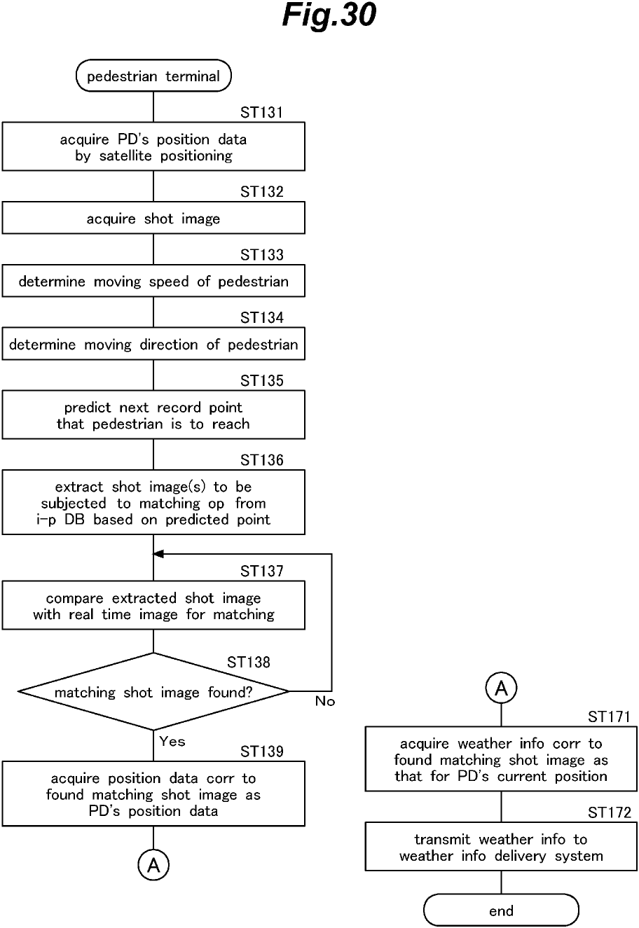

Next, an operation procedure of a pedestrian terminal 1 of the sixth embodiment will be described. FIG. 30 is a flow chart showing the operation procedure of the pedestrian terminal 1.

The pedestrian terminal 1 performs the same operations as in the first embodiment (see FIGS. 7(A), 7(B), and 7(C)).

The roadside device 3 performs the same operations as the first embodiment (see FIGS. 10(A) and 10(B)).

As shown in FIG. 21, as in the first embodiment (see FIG. 8), the processor 18 in the pedestrian terminal 1 performs processing steps from acquiring the position data of the pedestrian’s position by using the satellite positioning device 14, to acquiring the position data of the record point associated with a matching shot image as the position data of the pedestrian’s current position (ST131 to ST139).

Next, in the present embodiment, the processor 18 performs the weather information acquisition operation, i.e., acquiring weather information (such as sunny, rainy, or snowy condition) corresponding to the record point where a matching shot image is found, as weather information for the pedestrian’s current position (ST171).

Next, in response to a transmission instruction from the processor 18, the cellular communication device 19 transmits weather information acquired in the weather information acquisition operation to the weather information delivery server 121 (ST172).

### Seventh Embodiment

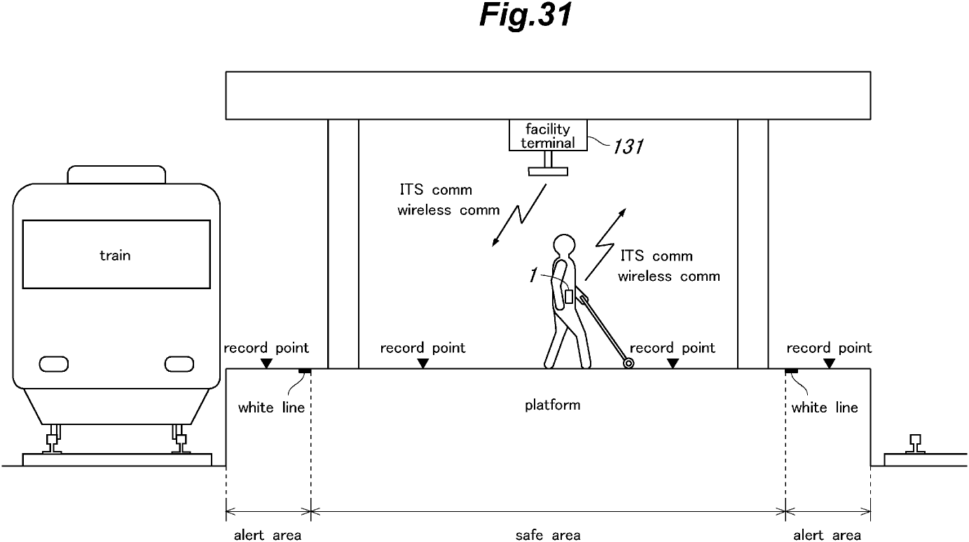

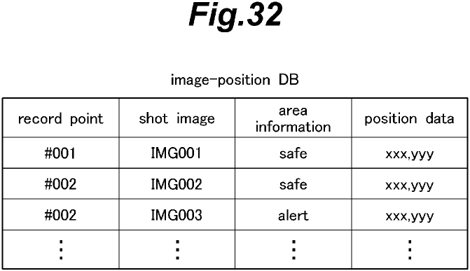

Next, a facility monitoring system according to a seventh embodiment of the present disclosure will be described. Except for what will be discussed here, the seventh embodiment is the same as the above described embodiments. FIG. 31 is a diagram showing an overall configuration of the facility monitoring system of the seventh embodiment. FIG. 32 is an explanatory diagram showing an example of stored data in an image-position DB of the seventh embodiment.

At railroad stations, accidents occur when a pedestrian (passenger) who is walking on a platform falls off the platform or comes into contact with a train. Such accidents occur more frequently when a pedestrian is visually impaired. Thus, there is a need for providing an alert to a pedestrian when the pedestrian enters a dangerous area, i.e., an area on the track side of a white line on the platform.

In view of this, a system of the present embodiment is configured such that an alert area (specific area) is preset, the alert area comprising a dangerous area on the track side of a white line on the platform, and a no-entry area where outsiders are not allowed to enter, and that an image-position DB contains position data of each record point in association with a shot image and with area information indicating where the record point is located within the alert area (see FIG. 32).

The pedestrian terminal 1 acquires position data (latitude and longitude) of a record point associated with a matching shot image to a real time image found in the image matching operation on the image-position DB, as the position data of the pedestrian’s current position. When determining that the pedestrian is in the alert area based on area information corresponding to the record point associated with a matching shot image, the pedestrian terminal 1 provides an alert to the pedestrian.

In the present embodiment, a facility terminal 131 (base station device) is installed on or near the platform. The facility terminal 131 has the same configuration as the roadside device 3 in the first embodiment (see FIG. 6). The facility terminal 131 contains an image-position DB, and delivers record information in the image-position DB to pedestrian terminals 1 on or near the platform. In other cases, a management server installed on or near a platform may contain the image-position DB, and deliver record information in the image-position DB to pedestrian terminals 1 via the facility terminal 131.

In this way, a system of the present embodiment can provide an alert to a pedestrian when the pedestrian enters an alert area (e.g., an area on the track side of a white line on the platform), thereby ensuring the safety of users of the facility, in particular, visually impaired users.

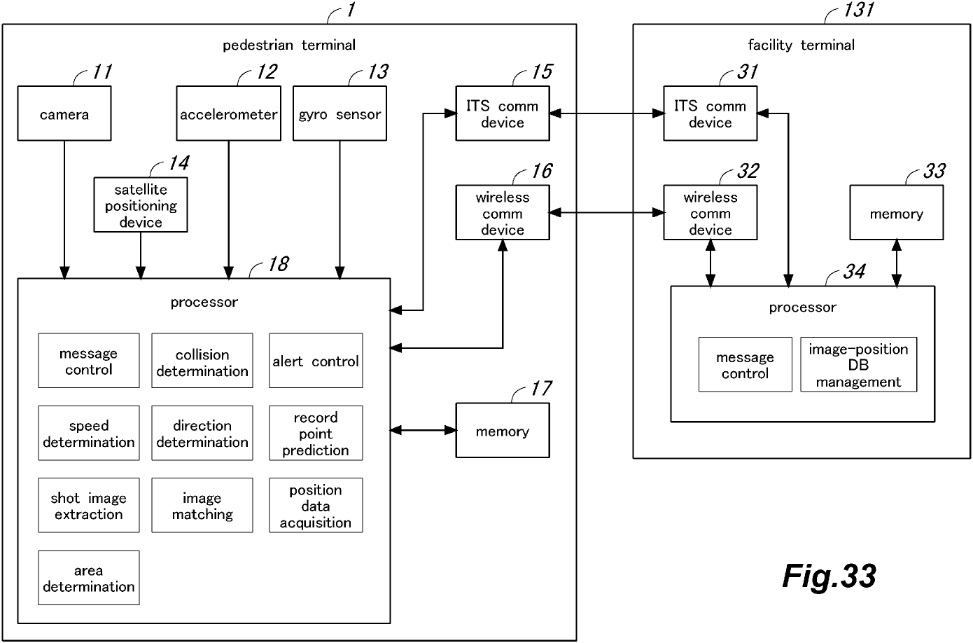

Next, schematic configurations of a pedestrian terminal 1 and a facility terminal 131 of the seventh embodiment will be described. FIG. 33 is a block diagram showing schematic configurations of the pedestrian terminal 1 and the facility terminal 131.

The pedestrian terminal 1 includes a camera 11, an accelerometer 12, a gyro sensor 13, a satellite positioning device 14, an ITS communication device 15, a wireless communication device 16, a memory 17, and a processor 18, as in the first embodiment (see FIG. 6).

The processor 18 of the pedestrian terminal 1 performs the same operations as the first embodiment (see FIG. 6), including a message control operation, a collision determination operation, an alert control operation, a speed determination operation, a direction determination operation, a record point prediction operation, a shot image extraction operation, an image matching operation, and position data acquisition operation. In the present embodiment, the processor 18 further performs an area determination operation.

In the area determination operation, the processor 18 determines whether a pedestrian is in an alert area based on area information corresponding to a record point associated with a matching shot image found in the image matching operation.

In the area determination operation, when determining that the pedestrian is within an alert area, the pedestrian terminal 1 provides an alert to the pedestrian. Examples of alerts include outputting sound from a speaker in the pedestrian terminal 1 and activating a vibrator in the pedestrian terminal 1.

In the present embodiment, the pedestrian terminal 1 determines whether or not a pedestrian is within an alert area based on area information corresponding to a record point associated with a matching shot image found in the image matching operation. In the other cases, the pedestrian terminal 1 may determine whether or not a pedestrian is within an alert area based on position data of the pedestrian’s current position acquired in the position data acquisition operation and area map information indicating the boundary defining each alert area.

The facility terminal 131 (base station device) includes an ITS communication device 31, a wireless communication device 32, a memory 33, and a processor 34, as in the roadside device 3 of the first embodiment (see FIG. 6).

The memory 33 of the facility terminal 131 stores record information in the image-position DB. In the present embodiment, the image-position DB contains position data of each record point in association with a shot image of the record point and with corresponding area information indicating the record point is located in an alert area.

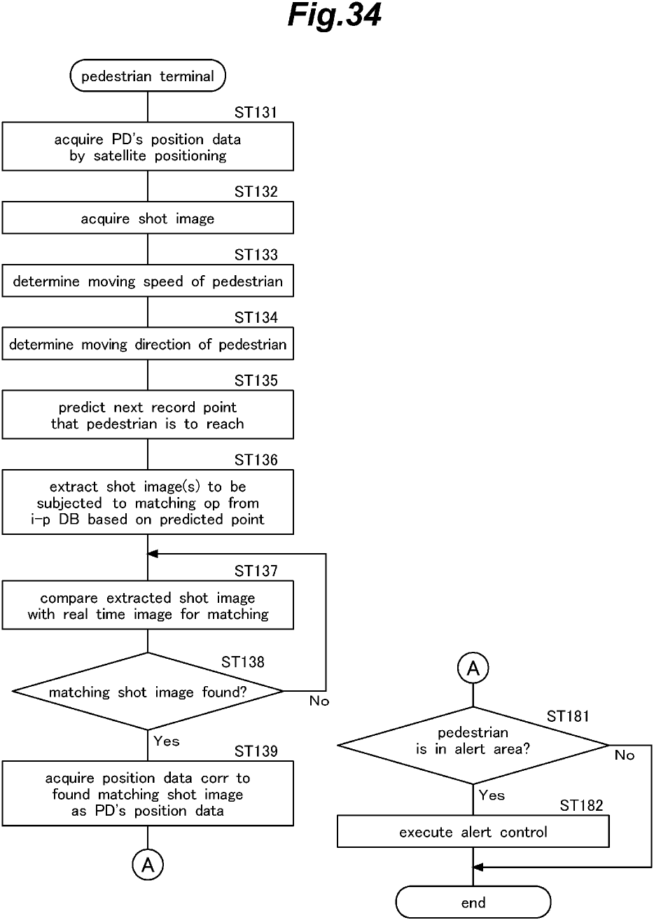

Next, an operation procedure of a pedestrian terminal 1 according to the seventh embodiment will be described. FIG. 34 is a flow chart showing an operation procedure of the pedestrian terminal 1.

The pedestrian terminal 1 performs the same operations as in the first embodiment (see FIGS. 7(A), 7(B), and 7(C)).

The facility terminal 131 performs the same operations as the roadside device 3 of the first embodiment (see FIGS. 10(A) and 10(B)).

As shown in FIG. 34, in the pedestrian terminal 1, the processor 18 performs processing steps (see FIG. 8) from acquiring the position data of the pedestrian’s position by using the satellite positioning device 14, to acquiring the position data of the record point associated with a matching shot image as the position data of the pedestrian’s current position data in the same manner as the first embodiment (ST131 to ST139 in FIG. 8).

Next, in the present embodiment, the processor 18 performs the area determination operation, i.e., determining whether or not a pedestrian is in an alert area based on area information corresponding to the record point associated with a matching shot image found in the image matching operation.

When determining that the pedestrian is in an alert area (Yes in ST181), the processor 18 controls a speaker or a vibrator so that the speaker or the vibrator provides a prescribed alert to the pedestrian (ST182).

The facility monitoring system can be applied not only to pedestrians but also to vehicles (such as motorcycles, bicycles, electric wheelchairs, farm machines, and mobility scooters). For example, the system may perform an image-based positioning operation when detecting that a vehicle is weaving, suddenly speeding up or slowing down, or speeding. Depending on the situation, the system may perform operations to a vehicle, such as providing an alert to a driver, activating an automatic brake system, and calling the police. This configuration can prevent dangerous actions such as a driver’s aggressive driving.

While specific embodiments of the present disclosure are described herein for illustrative purposes, the present disclosure is not limited to the specific embodiments. It will be understood that various changes, substitutions, additions, and omissions may be made for elements of the embodiments without departing from the scope of the invention. In addition, elements and features of the different embodiments may be combined with each other as appropriate to yield an embodiment which is within the scope of the present disclosure.

### INDUSTRIAL APPLICABILITY

A pedestrian device, an information collection device, a base station device, and a positioning method according to the present disclosure achieve an effect of enabling precise positioning of a pedestrian’s current position, fast execution of necessary processing operations, and reduced processing load on a data processing device, and are useful as a pedestrian device carried by a pedestrian and used for positioning the pedestrian to provide the pedestrian’s current position, an information collection device for collecting information required for positioning by the pedestrian device, a base station device for providing information required for positioning by the pedestrian device, and a positioning method performed by the pedestrian device.

GLOSSARY

| | |
|---|---|
| 1 | pedestrian terminal (pedestrian device) |
| 2 | in-vehicle terminal (in-vehicle device) |
| 3 | roadside device (base station device) |
| 5 | DB information collection terminal (information collection device) |
| 11 | camera |
| 12 | accelerometer |
| 13 | gyro sensor |
| 14 | satellite positioning device |
| 15 | ITS communication device |
| 16 | wireless communication device |
| 17 | memory |
| 18 | processor |
| 19 | cellular communication device |
| 21 | white cane |
| 22 | school bag |
| 31 | ITS communication device |
| 32 | wireless communication device |
| 33 | memory |
| 34 | processor |
| 35 | camera |
| 36 | display |
| 51 | camera |
| 52 | display |
| 53 | user interface |
| 54 | memory |
| 55 | processor |
| 101 | crew terminal (base station device) |
| 111 | store terminal (base station device) |
| 112 | user terminal |
| 121 | weather information delivery server |
| 122 | user terminal |
| 131 | facility terminal (base station device) |

1. A pedestrian device comprising:
a camera for capturing shot images of road surfaces under a pedestrian’s feet;
a sensor for detecting a movement of the pedestrian;
a memory for storing record information including a shot image of a road surface at a preset record point in association with position data of the record point, the shot image of the record point being preliminarily captured by the camera and stored in the memory; and
a processor for performing an image-based positioning operation, wherein the processor performs the image-based positioning operation by
predicting a next record point to be reached by the pedestrian based on the pedestrian’s movement status determined from detection results of the sensor;
extracting a shot image from the shot images stored in the memory based on the predicted next record point;
comparing the extracted shot image with a real time image for matching, aiming to find a matching shot image to a real time image, the real time image being provided from the camera in real time; and
acquiring the position data of the record point associated with the matching shot image as the position data of the pedestrian’s current position.

2. The pedestrian device as claimed in claim 1, further comprising a communication device configured to communicate with a base station device that maintains record information about a nearby area around the base station device,
wherein, when approaching the base station device, the communication device receives record information from the base station device, and
wherein, when the communication device receives record information from the base station device, the memory stores the received record information.

3. The pedestrian device as claimed in claim 1, wherein, when detecting a specific event in detection results of the sensor, the processor performs an image-based positioning operation to acquire position data of the pedestrian’s current position, and
wherein, when detecting no specific event in detection results of the sensor, the processor performs a pedestrian dead reckoning operation using the detection results of the sensor or a satellite positioning, to acquire position data of the pedestrian’s current position.

4. The pedestrian device as claimed in claim 3, wherein the specific event includes at least sudden acceleration or sudden change of a moving direction of the pedestrian.

5. An information collection device for collecting the record information to be stored in the pedestrian device as claimed in claim 1, the information collection device comprising:
a camera for capturing shot images of road surfaces under a pedestrian’s feet; and
a processor configured to set record points on the road in sequence by performing a parallax-based positioning operation to determine a distance between two points on the road surface based on parallaxes in shot images provided from the camera, to thereby collecting record information including the shot image at each record point in association with position data of the record point.

6. A base station device for providing information to the pedestrian device as claimed in claim 1, the base station device comprising:
a memory for storing record information about one or more record points in an area around the base station device, the record information including a shot image of a road surface at each of the record points in association with position data of the record point, the shot image of the record point being preliminarily captured by the camera and stored in the memory;
a communication device for communicating with the pedestrian device; and
a processor for controlling the communication device so that the base station device delivers the record information to the pedestrian device located nearby.

7. A positioning method, wherein the method is performed by a pedestrian device comprising: a camera for capturing shot images of road surfaces under a pedestrian’s feet; a sensor for detecting a movement of the pedestrian; a memory for storing record information including a shot image of a road surface at a preset record point in association with position data of the record point, the shot image being preliminarily captured by the camera and stored in the memory; and a processor, and
wherein the processor performs an image-based positioning operation, the image-based positioning operation comprising:
predicting a next record point to be reached by the pedestrian based on the pedestrian’s movement status determined from detection results of the sensor;
extracting a shot image from the shot images stored in the memory based on the predicted next record point;
comparing the extracted shot image with a real time image for matching, aiming to find a matching shot image to a real time image, the real time image being provided from the camera in real time; and
acquiring the position data of the record point associated with the matching shot image as the position data of the pedestrian’s current position.

8. A user management method for managing position data of a user carrying the pedestrian device as claimed in claim 1, wherein the memory of the pedestrian device stores record information including a shot image of a road surface at a preset record point in association with position data of the record point, and further with place information, the place information indicating whether or not the record point is included in a specific place, and
wherein the processor of the pedestrian device determines whether or not the user is present in the specific place based on the place information corresponding to the record point associated with the matching shot image.

9. A user management method for managing data of where a user carrying the pedestrian device as claimed in claim 1 is present in a facility, the facility including a plurality of specific areas, wherein the memory of the pedestrian device stores record information including a shot image of a road surface at a preset record point in association with position data of the record point, and further with area ID information, the area ID information indicating in which specific area in the facility the record point is located, and
wherein the processor of the pedestrian device identifies the specific area in which the user is present based on the area ID information corresponding to the record point associated with the matching shot image.

10. An information collection method for collecting weather information for where the pedestrian device as claimed in claim 1 is present, the weather information being collected for a weather information collection device, wherein the memory of the pedestrian device stores record information including a shot image of a road surface at a preset record point in association with position data of the record point, and further with weather information on weather under which the shot image was captured, and
wherein the processor of the pedestrian device acquires the weather information corresponding to the record point associated with the matching shot image as weather information on where the pedestrian device is present, and then controls a communication device of the pedestrian device to deliver the acquired weather information to the weather information collection device.

11. A facility monitoring method for detecting a user entering a specific area in a facility, the user carrying the pedestrian device as claimed in claim 1, wherein the memory of the pedestrian device stores record information including a shot image of a road surface at a preset record point in association with position data of the record point, and further with area information, the area information indicating whether the record point is located in the specific area in the facility, and
wherein the processor of the pedestrian device determines whether or not the pedestrian has entered the specific area based on the area information corresponding to the record point associated with the matching shot image.
